(19) United States
(12) Patent Application Publication
(10) Pub. No.: US 2019/0080403 A1
(43) Pub. Date: Mar. 14, 2019

(54) APPARATUSES, METHODS AND SYSTEMS FOR A MARGINAL CONTRIBUTION TO PERFORMANCE PLATFORM

(71) Applicant: Goldman Sachs & Co. LLC, New York, NY (US)

(72) Inventors: Douglas Lawrence Borden, New York, NY (US); Oliver Hansch, Summit, NJ (US); Youxun Shen, Short Hills, NJ (US); Xiaolin Xie, Jersey City, NJ (US)

(21) Appl. No.: 16/051,392

(22) Filed: Jul. 31, 2018

Related U.S. Application Data
(63) Continuation of application No. 12/705,270, filed on Feb. 12, 2010, now abandoned.
(60) Provisional application No. 61/152,588, filed on Feb. 13, 2009.

(51) Int. Cl. G06Q 40/04

(52) U.S. Cl. CPC G06Q 40/04

(57) ABSTRACT

The APPARATUSES, METHODS AND SYSTEMS FOR A MARGINAL CONTRIBUTION TO PERFORMANCE PLATFORM (“MCP PLATFORM”) brings about significant advances in the utility and efficacy of algorithmic trading. In one embodiment, the MCP Platform facilitates optimized trading of financial instruments by employing an optimization framework that extends down to the order-placement level. The MCP Platform may minimize a total, generalized cost associated with a trade by separating the overall optimization problem into current order placement decisions and future order placement decisions. Future order placement decisions may then be evaluated analytically and the current order placement decisions evaluated numerically to effectively reduce the dimensionality of the optimization problem and allow optimization to be performed in a relatively short period of time.

### RELATED APPLICATIONS

Applicant hereby claims priority under 35 USC § 119 for U.S. provisional patent application Ser. No. 61/152,588 filed Feb. 13, 2009, entitled “APPARATUSES, METHODS AND SYSTEMS FOR A MARGINAL CONTRIBUTION TO PERFORMANCE PLATFORM,” attorney docket no. 17209-093PV.

The entire contents of the aforementioned application is herein expressly incorporated by reference.

### FIELD

The present invention is directed generally to an apparatuses, methods, and systems of financial trading, and more particularly, to APPARATUSES, METHODS AND SYSTEMS FOR A MARGINAL CONTRIBUTION TO PERFORMANCE PLATFORM.

### BACKGROUND

Financial trading involves the buying and/or selling of financial instruments, such as stocks, bonds, derivatives, commodities, and/or the like, often within the context of a market exchange. Trades may be executed on behalf of customers by one or more traders, who may employ various trading strategies depending on the particular goals and/or requirements of the customer, trader, or trade in question. Among such strategies are market orders, whereby the trader executes a trade immediately at the current market price for the traded instrument, and limit orders, whereby the trader waits to execute the trade until a counterparty is found willing to trade at a pre-set price. Electronic trading systems have also come about, employing information technology systems to facilitate trades.

### SUMMARY

The APPARATUSES, METHODS AND SYSTEMS FOR A MARGINAL CONTRIBUTION TO PERFORMANCE PLATFORM (hereinafter “MCP PLATFORM”) achieves significant gains in increasing the utility and efficacy of algorithmic trading. In one embodiment, the MCP Platform facilitates optimized trading of financial instruments by facilitating an optimization framework that optimizes order-placement. The MCP Platform may minimize a total, generalized cost associated with a trade by separating the overall optimization process into current order placement decisions and future order placement decisions. Future order placement decisions may then be evaluated analytically and the current order placement decisions evaluated numerically to effectively reduce the dimensionality of the optimization problem and facilitate optimization to be performed quickly and efficiently.

In one embodiment, the MCP PLATFORM may receive a request from a trader indicating that a client has placed an order for a security with the trader. The MCP PLATFORM may retrieve order parameters and security parameters from the request. The MCP PLATFORM may also retrieve market parameters from one or more exchanges. If all required inputs for executing the client's order have not been received, the MCP PLATFORM may attempt to retrieve and/or construct such inputs based on the supplied data and/or based on the data in the MCP PLATFORM database and/or other data sources accessible by the MCP PLATFORM.

Stochastic processes for market variables may be specified based on the retrieved data. The implementation shortfall measuring the additional trading cost incurred for trading the security above the benchmark cost and calculated based on the retrieved security parameters may be specified. An implementation cost may be specified as a function of expected implementation shortfall and/or related values, such as risk aversion, and optimized to determine placement policies and/or trading schedules yielding minimal implementation cost values. The MCP PLATFORM may define a total implementation cost as the sum of the instantaneous implementation cost for a given order placement decision and the corresponding go-forward optimal implementation cost, as specified by a selected paradigm. Once the total implementation cost has been determined, the MCP PLATFORM may determine an optimal current order placement decision by, in one implementation, minimizing the total implementation cost as a function of order placement decisions, time horizon, and/or the like. The determined optimal current order placement may be passed to a trading system to execute a trade of the specified instruments and/or number of shares. If additional shares remain to be traded, the MCP PLATFORM may update the total implementation cost model with current values including current market data values, and the updated total implementation cost may be minimized again to yield the next optimal current order placement.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The accompanying appendices and/or drawings illustrate various non-limiting, example, inventive aspects in accordance with the present disclosure:

FIG. 1 provides an overview of the entities interactions with and among MCP system components in one embodiment of the MCP PLATFORM;

FIG. 2 illustrates data flow in one embodiment of the MCP PLATFORM operation;

FIG. 3 shows an implementation of overall logic flow in one embodiment of the MCP PLATFORM operation;

FIG. 4 is of a logic flow diagram illustrating selection of stochastic processes in one embodiment of the MCP PLATFORM;

FIG. 5 is of a logic flow diagram illustrating specifying implementation shortfall as a stochastic integral in one embodiment of the MCP PLATFORM;

FIG. 6 is of a logic flow diagram illustrating specifying implementation cost function in one embodiment of the MCP PLATFORM;

FIG. 7 is of a logic flow diagram illustrating constructing a paradigm for evaluating the implementation cost in one embodiment of the MCP PLATFORM;

FIG. 8 is of a logic flow diagram illustrating the determined optimal current order placement in one embodiment of the MCP PLATFORM;

FIG. 9 is of a drawing illustrating a non-limiting example of an Order Placement Decision question that may be solved by the MCP PLATFORM;

FIG. 10 is of a block diagram illustrating embodiments of the MCP PLATFORM controller;

FIG. 11 is of screen shot diagram illustrating one embodiment of the MCP PLATFORM user interface.

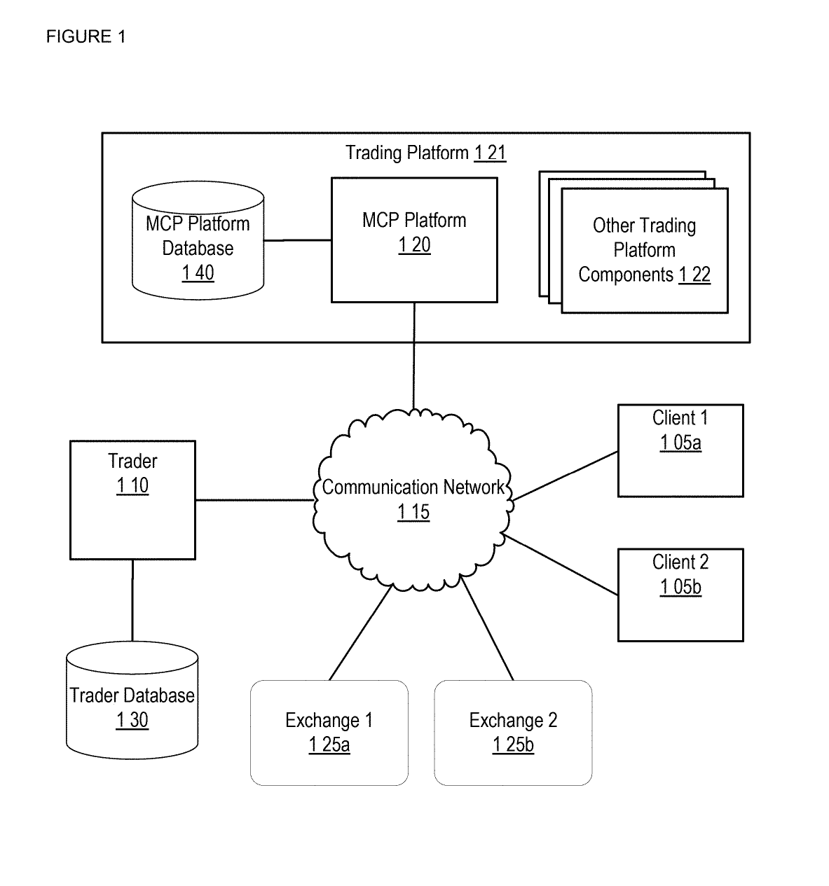

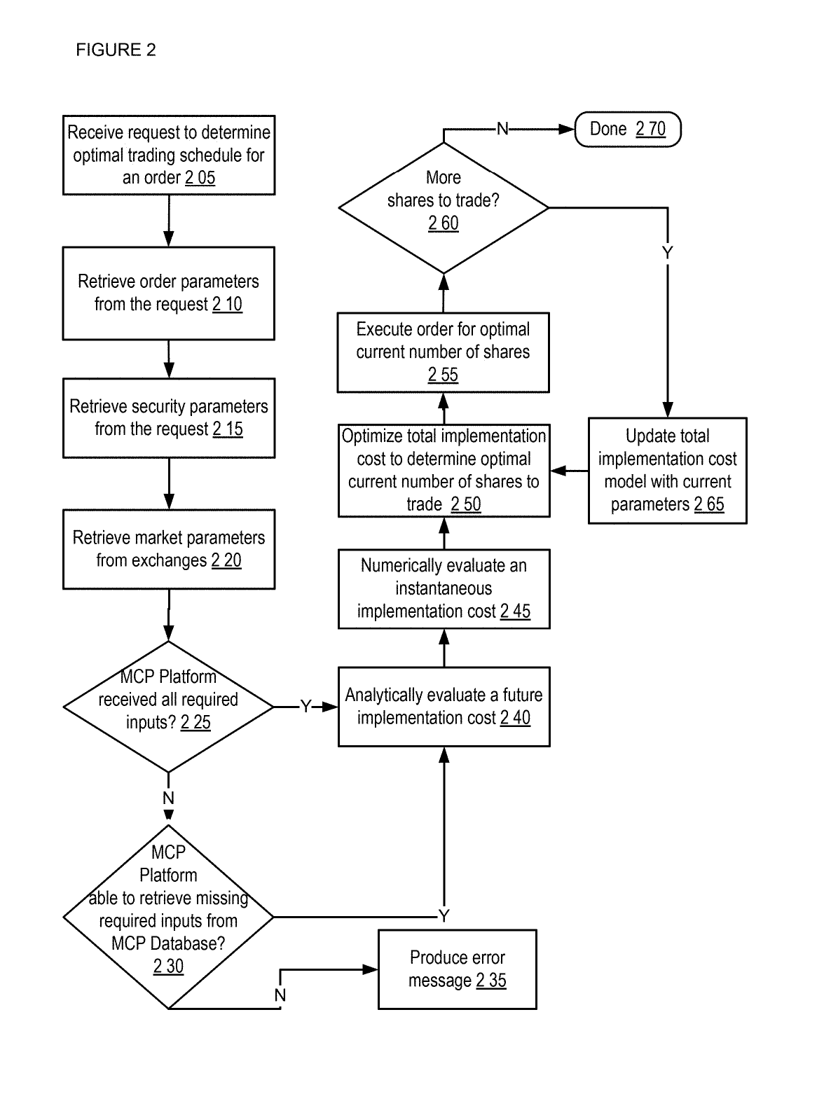

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### MCP PLATFORM

This disclosure details aspects of the MCP PLATFORM. It is to be understood that, depending on the particular needs and/or characteristics of a trader, buyer or seller of a financial instrument, financial instrument modeler and/or other MCP PLATFORM user, financial product, market and/or exchange, computer implementation, and/or the like, various embodiments of the MCP PLATFORM may be implemented that enable a great deal of flexibility and customization. The instant disclosure discusses embodiments and/or applications of the MCP PLATFORM directed to trading strategies for financial instruments, such as those that may be traded on a market exchange. However, it is to be understood that the system described herein may be readily configured and/or customized for a wide range of other applications and/or implementations. For example, aspects of the MCP PLATFORM may be adapted for non-exchange traded financial instruments, trading of other types of traded goods, services, commodities, and/or the like, predictive modeling, and/or any of a wide variety of other applications.

Furthermore, aspects of the MCP PLATFORM may be configured to generate, administer, and/or manage trading strategies for a wide variety of different financial instruments, securities, and/or the like beyond specific embodiments and/or implementations described in detail herein. For example, MCP PLATFORM generated trading strategies may be employed with and/or linked to equities, debts, derivatives, notes (e.g., structured notes), stocks, preferred shares, bonds, treasuries, debentures, options, futures, swaps, rights, warrants, commodities, currencies, funds, long and/or short positions, ETFs, insurance and/or risk transfer agreements, annuities, and/or other assets or investment interests. It should be noted that the MCP PLATFORM and/or MCP PLATFORM analysis may be configured to provide particular utility to investors, traders, brokers, specialists, and/or the like seeking to fulfill specific goals and/or purposes, such as to minimize risks, avoid impact costs, and/or the like. It is to be understood that the MCP PLATFORM may be further adapted to other implementations or investment, finance, and/or risk management applications.

In order to optimize various Order Placement Decisions during order execution, the MCP PLATFORM, in one embodiment, may seek to minimize implementation cost of trading, wherein implementation cost may include elements of impact cost, cost of risk, the literal cost of the stock, and/or the like. In one embodiment, the MCP PLATFORM may separate the overall Order Placement Decision optimization into two parts: (1) the current Order Placement Decisions, and (2) all future Order Placement Decisions. For example, a client may wish to buy 10,000 shares of S&P 500 ETF over the next hour. The MCP PLATFORM may seek to estimate and minimize the cost of trading by placing market orders at the ask price for shares of this ETF in such a way that all 10,000 shares will be purchased over the next hour. In order to decide the sizes of these market orders, the MCP PLATFORM may separate estimating the cost of trading into two parts to reduce the complexity of the estimation. In the first part, the MCP PLATFORM may use a paradigm (i.e. a mathematical model) for estimating the size of the optimal market order that minimizes the cost of trading in the current time period, such as in the next 1 minute. In the second part, the MCP PLATFORM may use a paradigm for estimating the size of the optimal market order that minimizes the cost of trading in all the later time periods, such as over the next 59 minutes. By comparing the costs of placing market orders with different sizes, the MCP PLATFORM may determine the optimal market order size in the current time period that minimizes the total estimated cost of trading. The MCP PLATFORM attempts to minimize the cost of trading by repeating these calculations in each of the subsequent time periods.

Optimization of Order Placement Decisions during order execution is a very tough problem—often referred to as “adaptive” or “dynamic” optimization. The problem is that one has so many variables to optimize, literally tens of thousands of individual order placements, that even the most advanced numerical optimization methods take several minutes to converge on a solution. Unfortunately, these decisions need to be re-optimized several times a second. In one embodiment to facilitate this optimization, the MCP PLATFORM may use derivative pricing theory and stochastic control theory to analytically evaluate part (2) related to future placement assuming a continuum limit, and may use numerical techniques to evaluate part (1) related to current placement to reduce the dimensionality of the optimization problem. In one implementation, using this approach may reduce the dimensionality of the optimization problem by three or more orders of magnitude, and may facilitate solving the optimization problem by the MCP PLATFORM in milliseconds or faster, as opposed to previous processing/time intensive analysis that involve calculations done over the course of minutes. These processing time savings are significant within the realm of financial transactions—where time literally is money. The MCP PLATFORM may also use less computational power to solve the optimization problem, reducing hardware requirements and increasing scalability.

FIG. 1 provides an overview of the entities interactions with and among MCP system components in one embodiment of the MCP PLATFORM. In FIG. 1, a client 105a or 105b places an order to trade securities with a trader 110. In one embodiment, the client may place the order using a communication network 115. In one implementation, the communication network 115 may be the Internet. In another implementation, the communication network 115 may be a private communication network between a client and the trader. It is to be understood, that while only one communication network 115 is shown for clarity, multiple distinct communication networks may exist connecting each of the system components and affiliated entities with each other. Furthermore, although illustrated as separate entities, it is to be understood that the MCP Platform facilitates significant flexibility and certain features and functionality may be combined or separated depending on the particular working implementation and the needs of the various users. For example, aspects of the MCP Platform 120 and the MCP PLATFORM database 140 may be part of a trading platform 121 having a variety of other components 122. In another example, aspects of the MCP Platform 120, the MCP PLATFORM database 140, and Trader 110 may be combined into a single financial transaction facilitation system. In another example, a client may place an order over a telephone network, while the trader may communicate with the MCP PLATFORM 120 over the Internet.

Upon receiving the order from the client, the trader, also referred to herein as a user, may use the MCP PLATFORM 120 to execute the order in an optimal or near optimal way. In one embodiment, the MCP PLATFORM may use data from various sources, such as from exchanges 125a and/or 125b, supplied by the trader from the trader database 130, from the MCP PLATFORM database 140, and/or the like, to determine an optimized trading solution that includes schedule facilitation for execution on one or more exchanges 125a and/or 125b. By way of non-limiting example only, exchanges 125a, 125b may be any financial exchanges such as the NYSE, NASDAQ, and/or the like.

Below is a table illustrating some of the notation used in the following description of the MCP PLATFORM. It is to be understood that this is not an exhaustive list of notation used in the description, and that other notation may appear throughout the specification.
X: remaining position
y: market order trade rate
N: initial position
T: horizon
μ: drift
σ: volatility
Σ: covariance matrix
f: fill rate
δ: half spread
γ̅: market volume flow rate
γ temporary market impact function exponent
α: temporary market impact function coefficient

$$\underline{φ} \underline{:} \underline{\frac{α}{{y}^{γ}}}$$

Φ: diagonal matrix with diagonal elements ϕᵢ
η: permanent market impact function coefficient
IS: implementation shortfall
U or IC: implementation cost
S: price
C: diff between realized IS and expected IS
λ or κ: risk aversion coefficient
β: beta value with respect to some benchmark
V: cumulative volume profile
v: instantaneous volume profile

In one embodiment, the MCP PLATFORM also makes certain assumptions including: stock price follows an arithmetic random walk with drift μ and volatility σ; an order of N shares should be executed within an interval of length T; passive spread-capture strategy is estimated to be filled at a rate f shares/sec; and y(t) is the trading schedule of market orders, whose unit is shares/sec.

FIG. 2 illustrates data flow in one embodiment of the MCP PLATFORM operation. At 205, the MCP PLATFORM may receive an indication from a trader that a client has placed an order for a security with the trader. In one embodiment, such an indication may be in the form of a request to determine an optimized trading schedule for the order.

In one embodiment, the request may include one or more order parameters, such as stock symbol, quantity of shares to trade, time within which to execute the order, and/or the like, specified by the client. At 210, the MCP PLATFORM may retrieve such order parameters from the request and place them in corresponding variables used by the MCP PLATFORM program code to store order parameters. For example, a C++ function that parses the request and copies the order parameters into corresponding variables may be used to facilitate the retrieval.

In another embodiment, the request may also include one or more security parameters, such as beta, drift, volatility, temporary market impact coefficient, temporary market impact exponent, and/or the like, specified by the trader. In one implementation, beta may indicate risk of the security compared to the market, drift may indicate how the price of the security varies with time, volatility may indicate the volatility of the security price, and temporary market impact coefficient and temporary market impact exponent may indicate how the price of a security may be temporarily affected by the temporary liquidity imbalance due to placement of an order. In one implementation, the trader may specify one or more security parameters based on values stored in the trader database 130. For example, the trader may calculate the value of beta based on historical data regarding the security stored in the trader database. At 215, the MCP PLATFORM may retrieve such security parameters from the request and place them in corresponding variables used by the MCP PLATFORM program code to store security parameters.

The MCP PLATFORM may retrieve market parameters from one or more exchanges 220. The market parameters retrieved by the MCP PLATFORM may include security bid price, security ask price, volume, and/or the like parameters that facilitate the operation of the MCP PLATFORM. In one embodiment, the MCP PLATFORM may be part of a financial transaction facilitation system and the market parameters may be retrieved by making a C++ function call to a module of the financial transaction facilitation system that provides market data. In another embodiment, the market parameters may be retrieved from an exchange through a market data feed via a communications network. In one implementation, the data feed may be in an XML format and may take on the following form:

```
<XML>
        <Asset>
                <asset_symbol>XYZ</asset_symbol>
                <bid_price>100.01</bid_price>
                <ask_price>100.02</ask_price>
                <volume>500,000</volume>
        </Asset>
</XML>
```

In another implementation, the data feed may be a text file containing data fields separated by a separator character, such as “|” and may take on the following form:

asset_symbol|bid_price|ask_price|volume

In one implementation, data from a market data feed may be extracted by parsing a data file, such as by using the Perl m// operator (e.g. m/.*|/). In another implementation, data from multiple data feeds may be received and combined in a variety of ways. For example, if two or more feeds supply data regarding the same market parameter, the MCP PLATFORM may pick the value from a preferred feed, take the average value, and/or pick the value supplied by the greatest number of feeds.

The MCP PLATFORM may make a determination at 225 as to whether all required inputs for executing the client's order have been received. In one embodiment, the list of the required inputs used by the MCP PLATFORM may be specified by a MCP PLATFORM administrator and may be stored in a configuration file used by the MCP PLATFORM. In another embodiment, the list of these parameters may be hard coded into a software program that facilitates the operation of the MCP PLATFORM, such as a software program written in C++.

If not, at 230 the MCP PLATFORM may attempt to retrieve and/or construct such inputs based on the supplied data and/or based on the data in the MCP PLATFORM database and/or other data sources accessible by the MCP PLATFORM. For example, if the MCP PLATFORM did not receive a security parameter specifying beta, the MCP PLATFORM may attempt to construct a measure of beta based on historical market data, if such data is available in MCP PLATFORM database and/or other data sources accessible by the MCP PLATFORM.

In one embodiment, security parameters may be stored in the MCP PLATFORM database, such as a SQL database, using Microsoft SQL Server, MySQL, and/or the like. In one implementation, the security parameters may be inserted into the database using an INSERT command that may take on the following form:

INSERT INTO SecurityParametersTable (drift, volatility, beta)

VALUES (drift_value, volatility_value, beta_value)

In one implementation, security parameters maybe retrieved from the MCP PLATFORM database using a SELECT command that may take on the following form:

SELECT drift, volatility, beta

FROM SecurityParametersTable

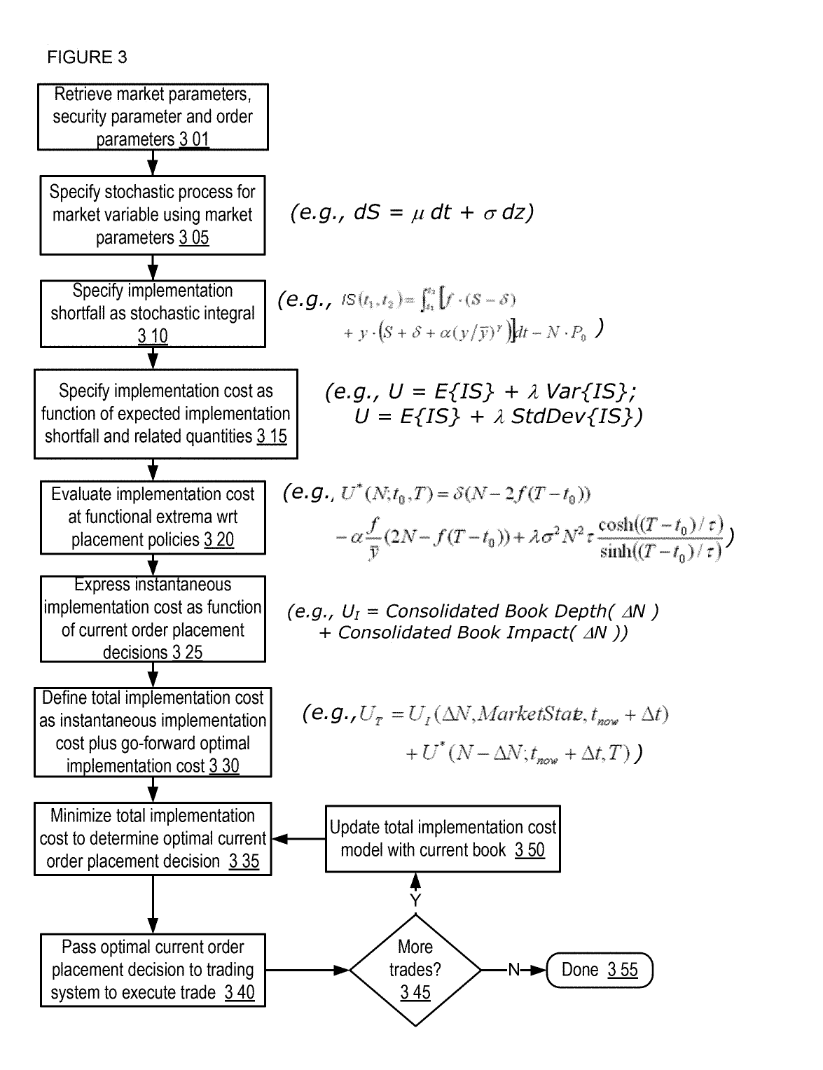

If the MCP PLATFORM is not able to retrieve and/or construct the missing input values, the MCP PLATFORM may produce an error message alerting the trader 235. Otherwise, the MCP PLATFORM may analytically evaluate a future implementation cost as a function of future number of shares to trade at 240. In one embodiment, the MCP PLATFORM may split the time horizon into a current time period (t_{now}, t_{now}+Δt) in which to trade ΔN shares and a future time period (t_{now}+Δt, T) in which to trade N_{remaining} shares that remain to be traded. In order to analytically evaluate the future implementation cost, the MCP PLATFORM may retrieve an implementation cost function evaluated at functional extrema based on an implementation shortfall, as described in more detail in FIG. 3. In one implementation, such implementation cost function may be selected by the user and specified in the request.

In order to numerically evaluate an instantaneous implementation cost as a function of current number of shares to trade at 245, the MCP PLATFORM may retrieve an instantaneous implementation cost function expressed as the sum of the direct cost of trading ΔN shares immediately, and the impact cost of trading ΔN shares immediately. In one implementation, such implementation cost function may be selected by the user and specified in the request.

The total implementation cost is the sum of the future implementation cost and the instantaneous implementation cost. At 250, the MCP PLATFORM may determine an optimal current number of shares ΔN to trade at 255 from the remaining quantity of shares N_{remaining} by finding the optimal current number of shares to trade that minimizes the total implementation cost based on current parameters (e.g. Δt, T, expected spread, volatility, impact coefficients, and/or the like).

If the MCP PLATFORM determines at 260 that all N shares have not yet been traded, the MCP PLATFORM may update the total implementation cost model with current parameters. The MCP PLATFORM may continue to re-optimize and re-execute orders for an optimal current number of shares until the MCP PLATFORM determines that the total quantity of shares has been traded 270.

FIG. 3 shows an implementation of overall logic flow in one embodiment of the MCP PLATFORM operation. At 301, upon receiving a request to determine an optimized trading schedule for a client order, the MCP PLATFORM may retrieve one or more market parameters (e.g. security bid price, security ask price, volume), security parameters (e.g. beta, drift, volatility) and/or order parameters (e.g. security symbol, time within which to execute the order) from one or more data sources.

Stochastic processes for market variables may be specified based on the retrieved data at 305. In one implementation, market variables may comprise the price and/or volume trading of a financial instrument. In one implementation, the stochastic process specified for market variables comprises an arithmetic random walk. For example, the stochastic process specified for the price of a financial instrument may comprise an arithmetic random walk and may take on the following form:

dŜ(t)=μdt+σdB(t)

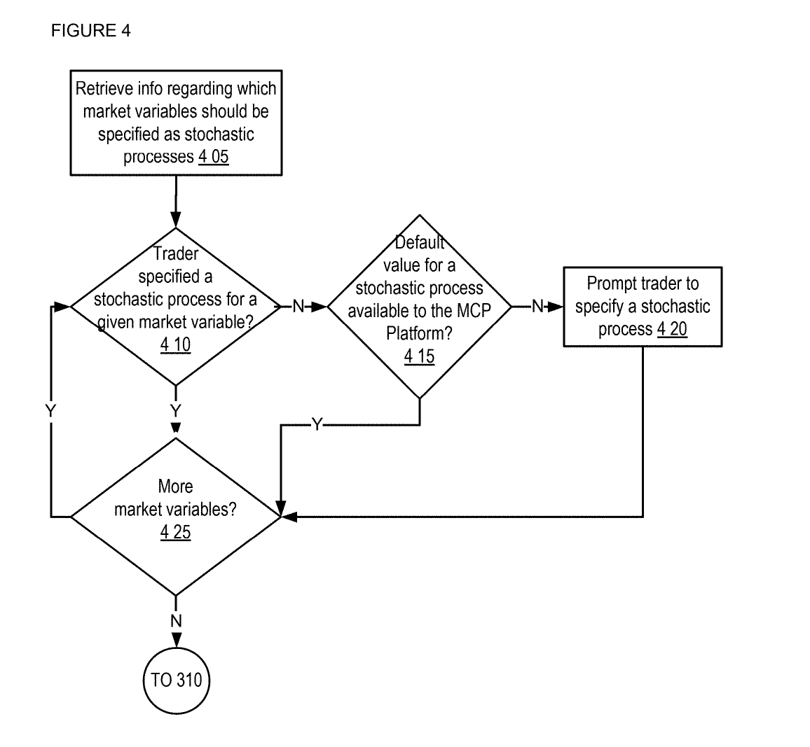

In this stochastic process, the way in which a security's intrinsic price dŜ(t) changes over time is expressed based on drift μ, which may indicate how the price of the security varies based on time t, and volatility σ, which may indicate the volatility of the security price based on a random walk variable dB(t). In one embodiment, the values of drift and volatility may be based on the retrieved security parameters. For further detail regarding selection of stochastic processes see FIG. 4.

The implementation shortfall may be defined as the difference between the realized trading cost and some target benchmark. For example, a target benchmark, such as an arrive price benchmark, may specify an optimal trading cost for trading a security. The implementation shortfall measures the additional trading cost incurred for trading the security above the benchmark cost. In one embodiment, a client and/or a trader may choose a benchmark based on market expectations, risk tolerance, and/or the like. For example, the arrival price benchmark may be harder to game, but may be noisier than the VWAP benchmark. In one embodiment, the benchmark cost may be calculated based on the retrieved security parameters. The implementation shortfall may be specified as a stochastic integral 310. In one implementation, implementation shortfall (IS) may be defined as follows:

IS=∫₀^{T}(y·Sₘ(t,y)+f·Sₚ(t)−\tilde{y}(t)·Ŝ(t))dt,

where Ŝ(t) is the fundamental stock price (i.e., mid-quote), \tilde{y}(t) is the benchmark trading schedule, y is the market order schedule, Sₘ(t,y) is the observed price of executing market order y, f is the fill rate of passive limit orders, and Sₚ (t) is the observed price of executing passive limit orders f.

In this implementation, the fundamental stock price may be based on the stochastic process describing how a security price changes over time and make take on the following form:

Ŝ(t)=S₀+μt+σB(t)

The realized price of executing a market order may also be based on the stochastic process describing how a security price changes over time and make take on the following form:

$$\begin{matrix}IS = {\int }_{0}^{T} ( y \cdot {S}_{m} ( t , y ) + f \cdot {S}_{p} ( t ) - \tilde{y} ( t ) \cdot \hat{S} ( t ) ) dt \\ = {\int }_{0}^{T} ( y \cdot {S}_{m} ( t , y ) + f \cdot {S}_{p} ( t ) ) dt - {S}_{0} \cdot N \\ = {\int }_{0}^{T} ( y \cdot ( {S}_{m} ( t , y ) - {S}_{0} ) + f \cdot ( {S}_{p} ( t ) - {S}_{0} ) ) dt \\ = {\int }_{0}^{T} ( y \cdot δ - f \cdot δ + {α ( \frac{y}{\overline{y}} )}^{γ} \cdot y ) dt + {\int }_{0}^{T} ( μ t + σ B ) ( y + f ) dt \\ = {\int }_{0}^{T} ( y \cdot δ - f \cdot δ + {α ( \frac{y}{\overline{y}} )}^{γ} \cdot y ) dt + {\int }_{0}^{T} μ Xdt + {\int }_{0}^{T} σ XdB\end{matrix}$$

where y̅(t) is the expected market volume flow rate, a is the temporary impact coefficient, and market orders pay spread δ_{α} as well as temporary market impact

$${α ( \frac{y}{\overline{y}} )}^{γ} .$$

In one embodiment, the implementation shortfall may comprise a stochastic integral of the difference between a realized cost for a traded instrument and an arrive price benchmark cost, and may take on the following form:

$$\begin{matrix}IS = {\int }_{0}^{T} ( y \cdot {S}_{m} ( t , y ) + f \cdot {S}_{p} ( t ) - \tilde{y} ( t ) \cdot \hat{S} ( t ) ) dt \\ = {\int }_{0}^{T} ( y \cdot {S}_{m} ( t , y ) + f \cdot {S}_{p} ( t ) ) dt - {S}_{0} \cdot N \\ = {\int }_{0}^{T} ( y \cdot ( {S}_{m} ( t , y ) - {S}_{0 } ) + f \cdot ( {S}_{p} ( t ) - {S}_{0} ) ) dt \\ = {\int }_{0}^{T} ( y \cdot δ - f \cdot δ + {α ( \frac{y}{\overline{y}} )}^{γ} \cdot y ) dt + {\int }_{0}^{T} ( μ t + σ B ) ( y + f ) d t \\ = {\int }_{0}^{T} ( y \cdot δ - f \cdot δ + {α ( \frac{y}{\overline{y}} )}^{γ} \cdot y ) dt + {\int }_{0}^{T} μ Xd t + {\int }_{0}^{T} σ XdB\end{matrix}$$

where the last step follows from integration by parts.

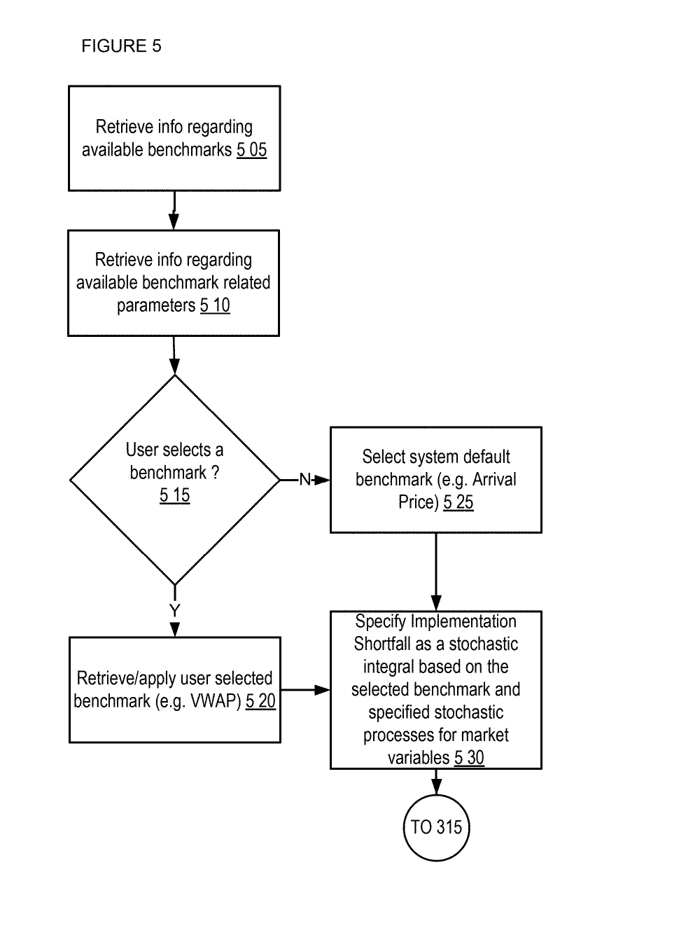

In another embodiment, the implementation shortfall may comprise a stochastic integral of the difference between a realized cost for a traded instrument and a volume weighted average price (VWAP) benchmark cost. Let V(t)=∫₀^{t}v(t)dt denote the normalized cumulative volume profile. V(t) may be a monotonically increasing function, where V(0)=0 and V(T)=1. In one implementation, the implementation shortfall corresponding to the VWAP price benchmark may be given by:

$$\begin{matrix}IS = {\int }_{0}^{T} ( y \cdot δ - f \cdot δ + {α ( \frac{y}{\overline{y}} )}^{γ} \cdot y ) dt + {\int }_{0}^{T} ( f + y - \tilde{y} ) \hat{S} ( t ) d t \\ = {\int }_{0}^{T} ( y \cdot δ - f \cdot δ + {α ( \frac{y}{\overline{y}} )}^{γ} \cdot y ) dt + {\int }_{0}^{T} μ ( X - ( 1 - V ) N ) dt + \\ {\int }_{0}^{T} σ ( X - ( 1 - V ) N ) d B\end{matrix}$$

where the last step follows from integration by parts. Since the volume profile can be highly uncertain, VWAP analysis tends to be more difficult than its arrival price counterpart. See FIG. 5 for further details regarding specifying the implementation shortfall as a stochastic integral.

An implementation cost, also referred to herein as utility, may be specified as a function of expected implementation shortfall and/or related values 315. The function specifying implementation cost may be selected by a trader, by the MCP PLATFORM administrator, or may be hard coded into the MCP PLATFORM based on beliefs regarding the tradeoffs between using a less accurate proxy of traders' impatience when trading securities, such as a mean-variance-measure—associated with less computational complexity, and using a better proxy, such as a mean-risk-measure, having increased computational complexity.

In one embodiment, implementation cost weighs both the expected transaction cost and execution risk. For example, the implementation cost may comprise a sum of an expectation value for the implementation shortfall and an expectation risk, such as a variance and/or standard deviation of the implementation shortfall multiplied by a risk tolerance and/or aversion factor. For example, the risk aversion factor κ may be provided by the client, may be selected by the trader, or may be a default value in the MCP PLATFORM. In one implementation, the risk aversion factor may be specified quantitatively. In another implementation, the risk aversion factor may be specified as a qualitative value (e.g.: aggressive, moderate, conservative) and converted by the MCP PLATFORM into a predetermined corresponding quantitative value.

In one implementation, implementation cost may be measured using a mean-variance-measure and may take on the following form:

IC=E[IS]+κ Var[IS]

In another implementation, implementation cost may be measured using a quadratic-utility-measure and may take on the following form:

IC=_{E}[IS]+κE[IS²]

In yet another implementation, implementation cost may be measured using a mean-risk-measure and may take on the following form:

IC=E[IS]+K√(Var[IS])

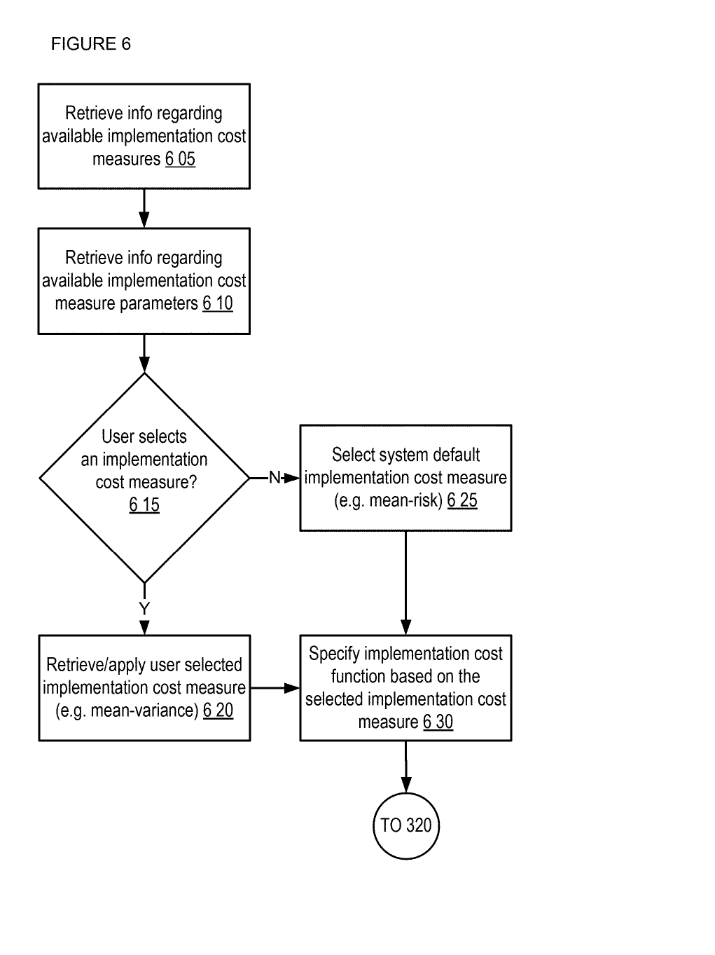

In one embodiment, the preferred implementation cost measure may be selected based on security parameters (e.g. beta, drift, volatility), order parameters (e.g. security symbol, time within which to execute the order), and/or the like. For example, if a client desires to execute a trade involving a large portfolio of stocks within one hour, the mean-variance-measure may be selected as the preferred implementation cost measure. However, if a client desires to execute a trade involving a single security over the course of a day, the mean-risk-measure may be selected as the preferred implementation cost measure. In another embodiment, the preferred implementation cost measure may be selected based on easy of use associated with the implementation cost measure as perceived by the client and/or the user. See FIG. 6 for further details regarding specifying the implementation cost.

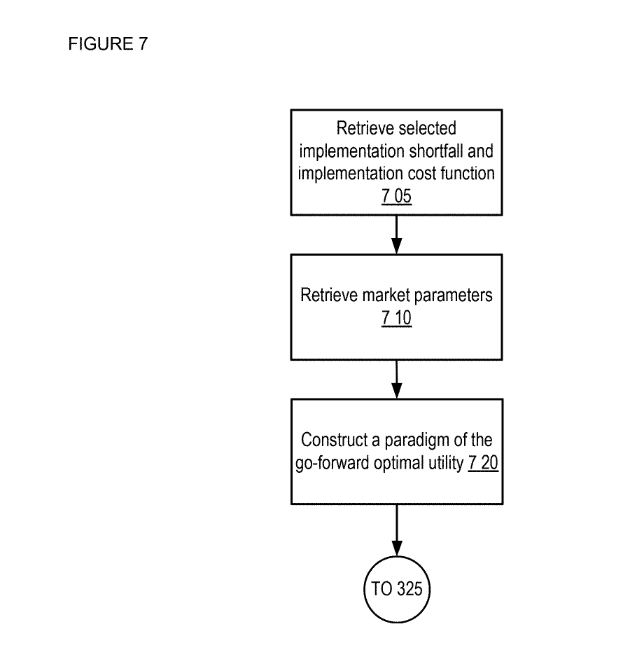

In various embodiments, the implementation cost may be optimized to determine placement policies and/or trading schedules yielding minimal implementation cost values. These extrema may then be determined by evaluating the implementation cost at those placement policies and/or trading schedules to yield optimized implementation cost at 320. A preferred trading strategy used in this evaluation may be selected by a MCP PLATFORM administrator, selected by a MCP PLATFORM user, hard coded into a software program, and/or the like. For example, the preferred trading strategy may be selected based on computational complexity, market conditions, set of securities, desired speed of execution, and/or the like. For example, if the order parameters indicate that a client wants to trade a single stock within the course of a day, an adaptive mean-variance strategy for a single stock may be used. If the order parameters indicate that a client wants to trade a portfolio of stocks within the course of a few minutes, a non-adaptive mean-variance strategy for a portfolio of stocks may be used instead. A variety of paradigms may be used to evaluate implementation cost in various embodiments as illustrated by non-limiting paradigm examples described in the section entitled Implementation Cost Paradigms. See FIG. 7 for further details regarding constructing a paradigm for evaluating the implementation cost.

An immediate contribution to the implementation cost, e.g., an instantaneous implementation cost, may be expressed as a function of current and/or immediate order placement and/or trading decisions 325. In one implementation, the immediate contribution to implementation cost is given by:

U_{I}(ΔN)=δ_{α·o}· min(ΔN,N_{touch})+(δ_{α·o}+δₚ)· max(ΔN−N_{touch},0)+α·ΔN/(y̅·Δt)*(½+1/(1+e^{-(N}^{_{touch}}^{/N̅}^{_{touch}}⁾)

where the first two terms represent direct cost of trading ΔN shares immediately, and the third term represents the impact cost.

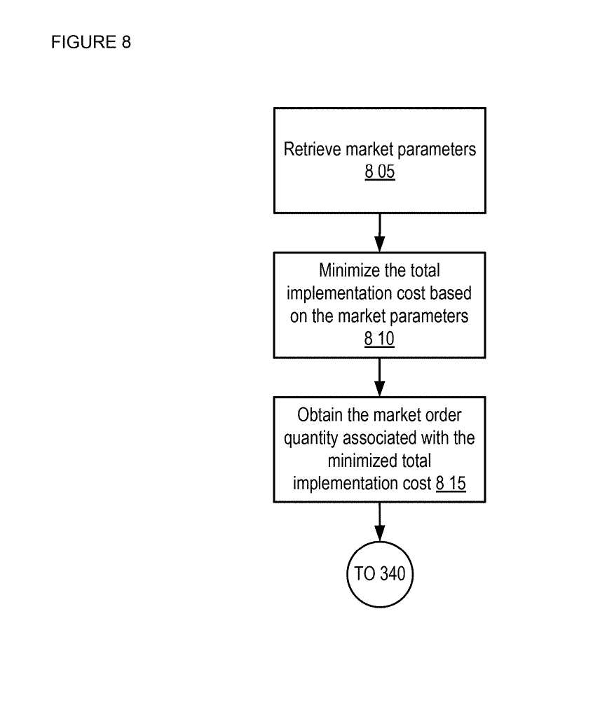

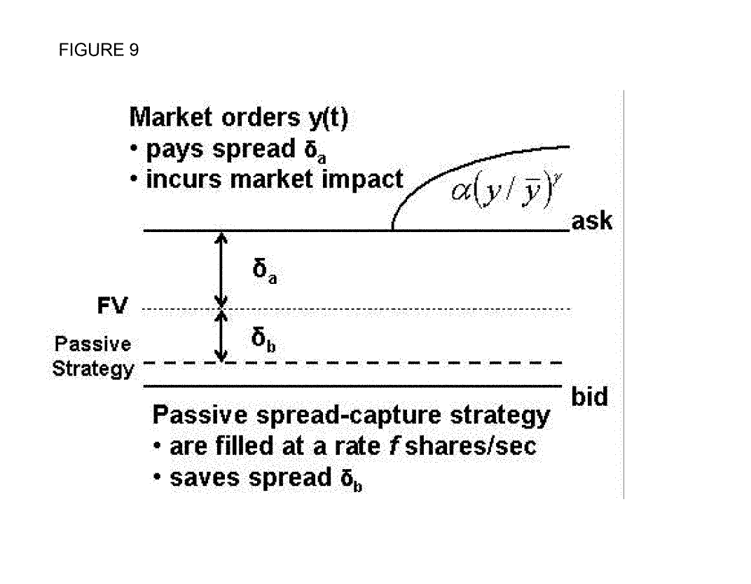

The MCP PLATFORM may define a total implementation cost as the sum of the instantaneous implementation cost for a given order placement decision and the corresponding go-forward optimal implementation cost, as specified by the selected paradigm, at 330. Once the total implementation cost has been determined, the MCP PLATFORM may determine an optimal current order placement decision by, in one implementation, minimizing the total implementation cost as a function of order placement decisions, time horizon, and/or the like 335. See FIGS. 8 and 9 for further details regarding the determined optimal current order placement.

The determined optimal current order placement may, in one implementation, be passed to a trading system to execute a trade of the specified instruments and/or number of shares 340. In another implementation, the optimal current order placement may be provided for display to a broker, trader, investor, and/or the like to aid and/or instruct a trade made thereby. A determination may be made as to whether there are more trades to be executed 345, such as for one or more financial instruments for which the total implementation cost has been established at 335. If so, then the implementation cost model may be updated with the current book of tradable instruments 350, and the updated total implementation cost may be minimized again to yield the next optimal current order placement 335. Otherwise, the current round of trading is done 355.

FIG. 4 is of a logic flow diagram illustrating selection of stochastic processes in one embodiment of the MCP PLATFORM. In FIG. 4, information regarding which market variables should be specified as stochastic processes may be retrieved 405. In one implementation, such information may be stored in a MCP PLATFORM configuration file. In another embodiment, such information may be hard coded into a C++ software program.

In one embodiment, the MCP PLATFORM may determine whether a stochastic process for a market variable was selected by a MCP PLATFORM user at 410. For example, the MCP PLATFORM user may select a stochastic process for the market variable deemed to be best suited for given market conditions, set of securities, desired speed of execution, and/or the like. If so, the MCP PLATFORM may check whether other market variables need to be specified as stochastic processes at 425 and return to 410 until all the market variables on the list have been determined to be specified as stochastic processes.

If not, in one embodiment, the MCP PLATFORM may check at 415 whether a stochastic process for a market variable has been selected as a default value, such as by a MCP PLATFORM administrator. For example the MCP PLATFORM administrator may determine how the stochastic process for the market variable should be specified, and may update a configuration file storing default values to indicate that a selected stochastic process for the market variable should be used. In one implementation, the MCP PLATFORM administrator may update the default settings using a graphical user interface by typing in, selecting a radio button, selecting an option in a select box, and/or the like associated with the defined stochastic process for the market variable in an administration control panel of the MCP PLATFORM. In another implementation, the stochastic process for a market variable may be a default value by being hard coded into a software program, such as a software program written in C++. If there is a default value, the MCP PLATFORM may check whether other market variables need to be specified as stochastic processes at 425 and return to 410 until all the market variables on the list have been determined to be specified as stochastic processes.

If not, in one embodiment, the MCP PLATFORM may prompt the MCP PLATFORM user to select the stochastic process for the market variable at 420, such as by using a user interface of the MCP PLATFORM (e.g. an input box, a radio button, a select box, and/or the like), by selecting and/or entering it into an excel spreadsheet, and/or the like. Once all market variables have been specified as stochastic processes, a the MCP PLATFORM proceeds to 310 of FIG. 3.

FIG. 5 is of a logic flow diagram illustrating specifying implementation shortfall as a stochastic integral in one embodiment of the MCP PLATFORM. In FIG. 5, information regarding available benchmarks may be retrieved at 505. In one implementation, the list of available benchmarks may be specified in a configuration file of the MCP PLATFORM. In another implementation, the list of available benchmarks may be retrieved from the MCP PLATFORM database.

At 510, information regarding the available benchmark related parameters may be retrieved. In one embodiment, such information may be specified by the user of the MCP PLATFORM (e.g. risk tolerance). In another embodiment, the MCP PLATFORM may generate such parameters based on available data (e.g. historical data stored in the MCP PLATFORM database).

At 515, a determination may be made regarding whether the user selected a preferred benchmark. In one implementation, this determination may be made based on data contained in the user request. In another implementation, this determination may be based on the available benchmark related parameters (e.g. a user profile specifying the client's and/or the user's risk tolerance, stored in the MCP PLATFORM database).

If the user selected a preferred benchmark, the MCP PLATFORM may retrieve and/or apply such benchmark at 520. For example, such user selected benchmark may be the Volume Weighted Average Price (VWAP) benchmark. If the user did not select a preferred benchmark, the MCP PLATFORM may select a system default benchmark at 525. In one implementation, such system default benchmark may be the Arrival Price benchmark.

In one embodiment, implementation shortfall may be specified as a stochastic integral at 530 based on the selected benchmark and the specified stochastic processes for market variables.

FIG. 6 is of a logic flow diagram illustrating specifying implementation cost function in one embodiment of the MCP PLATFORM. In FIG. 6, information regarding available implementation cost measures may be retrieved at 605. In one implementation, the list of available implementation cost measures may be specified in a configuration file of the MCP PLATFORM. In another implementation, the list of available implementation cost measures may be retrieved from the MCP PLATFORM database.

At 610, information regarding the available implementation cost measure related parameters may be retrieved. In one embodiment, such information may be specified by the user of the MCP PLATFORM (e.g. ease of use associated with an implementation cost measure as perceived by the client and/or the user). In another embodiment, the MCP PLATFORM may generate such parameters based on available data (e.g. historical data stored in the MCP PLATFORM database).

At 615, a determination may be made regarding whether the user selected a preferred implementation cost measure. In one implementation, this determination may be made based on data contained in the user request. In another implementation, this determination may be based on the available implementation cost measure related parameters (e.g. a user profile specifying the client's and/or the user's perception of ease of use associated with an implementation cost measure, stored in the MCP PLATFORM database).

If the user selected a preferred implementation cost measure, the MCP PLATFORM may retrieve and/or apply such implementation cost measure at 620. For example, such user selected implementation cost measure may be the mean-risk-measure. If the user did not select a preferred implementation cost measure, the MCP PLATFORM may select a system default implementation cost measure at 625. In one implementation, such system default implementation cost measure may be the mean-variance-measure.

In one embodiment, implementation cost function may be specified based on the selected implementation cost measure at 630.

FIG. 7 is of a logic flow diagram illustrating constructing a paradigm for evaluating the implementation cost in one embodiment of the MCP PLATFORM. In FIG. 7, information regarding selected implementation shortfall and implementation cost function may be retrieved at 705. For example, in one implementation, such information may be retrieved from a cache storing information output at 530 and 630. In one embodiment, information regarding market parameters may also be retrieved at 710.

A paradigm of the go-forward optimal implementation cost may be constructed at 720. In one embodiment, such paradigm may be constructed based on evaluation of the implementation cost function at the functional extrema with respect to order placement policies, using variational calculus and stochastic control theory, associated with the selected implementation shortfall, implementation cost function, and market parameters. In one implementation, the evaluation of the implementation cost function at the functional extrema with respect to order placement policies may be stored in a database. In another implementation, the evaluation of the implementation cost function at the functional extrema with respect to order placement policies may be hard coded into a C++ software program.

FIG. 8 is of a logic flow diagram illustrating the determined optimal current order placement in one embodiment of the MCP PLATFORM. At 805, information regarding market parameters used in the evaluation of the total implementation cost may be retrieved. In one embodiment, numerical techniques may be used to minimize the total implementation cost based on the market parameters. At 815, a market order quantity associated with the minimized total implementation cost may be obtained. In one implementation, this may be a value of a C++ variable corresponding to the market order quantity that is associated with the minimized total implementation cost.

FIG. 9 is of a drawing illustrating a non-limiting example of an Order Placement Decision question that may be solved by the MCP PLATFORM: do we submit a market order now paying a half spread and market impact or wait on a limit order saving a half spread with the risk of not filling the order immediately and with the risk of the price deviating away from the arrival price benchmark further? As described above, in one embodiment, the MCP PLATFORM may solve this question by determining the optimal strategy or near optimal strategy for trading N shares in time interval T. In one embodiment, the MCP PLATFORM may output the market order size that should be placed during each sub-interval of the time interval T. It is to be understood that the MCP PLATFORM may solve a variety of Order Placement Decision questions. Other non-limiting examples of such questions may include: How many shares should I show now as a limit order with limit equal to the current best-bid? How many shares should I execute now as market orders? At what limit price should I post my shares on ECN-Z? How many shares should I post to DarkPoolX as Peg-Mid orders?

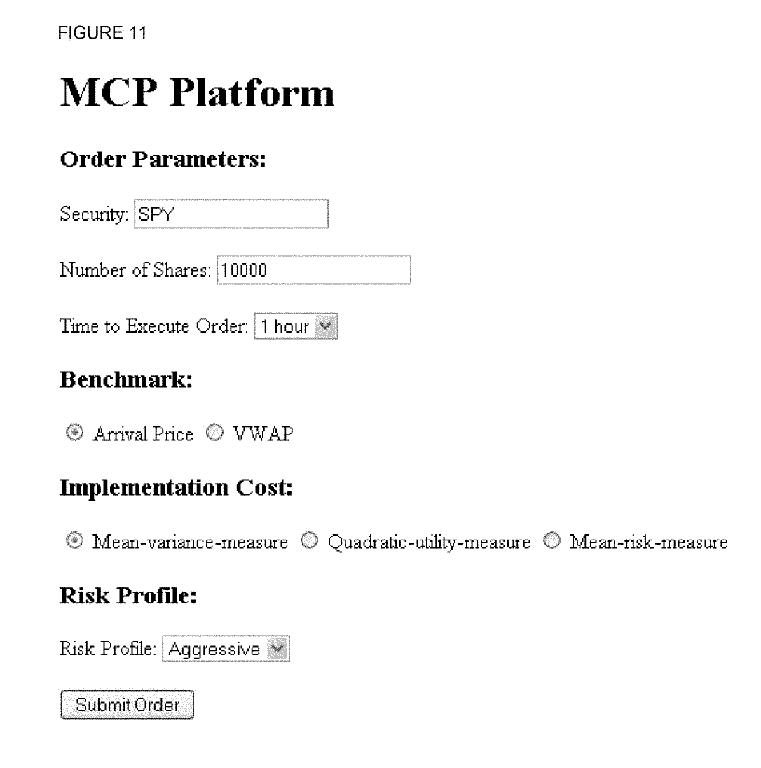

FIG. 11 is of screen shot diagram illustrating one embodiment of the MCP PLATFORM user interface. In one embodiment, a trader may place an order with the MCP PLATFORM by specifying various parameters. As illustrated in figure ii, the trader may input order parameters such as security symbol, order quantity, time horizon, and/or the like. The trader may also choose a benchmark to use such as arrival price benchmark, VWAP benchmark, and/or the like. The trader may also specify an implementation cost measure to use such as mean-variance-measure, quadratic-utility-measure, mean-risk-measure, and/or the like. The trader may also specify risk tolerance that the MCP PLATFORM should use to determine a risk-aversion coefficient. The trader may submit the order by clicking on the “Submit Order” button.

### Implementation Cost Paradigms

In one embodiment, a non-adaptive mean-variance strategy for trading a single stock with arrival price benchmark may be used. A non-adaptive trading strategy is a trading schedule y(t) that only depends on time, and the stochastic component comes from the random walk dB(t) of the mid-quote price. Using the non-adaptive mean-variance strategy may be less computationally intensive than using an adaptive mean-variance strategy. In one implementation, the expected implementation shortfall and the variance of the implementation shortfall for such a strategy may be expressed as:

$$E [ IS ] = {\int }_{0}^{T} ( δ \cdot y ( t ) - f \cdot δ + \frac{α}{{\overline{y}}^{γ}} \cdot {y ( t )}^{1 + γ} + ( μ - f η ) X ( t ) ) d t + \frac{η}{2} {N}^{2}$$

$$Var [ IS ] = {\int }_{0}^{T} {X}^{2} ( t ) {σ}^{2} d t$$

Depending on a user's expectation of market performance, the temporary market impact function exponent γ may take on a variety of values. In one implementation, the user may set the temporary market impact function exponent γ to between 0 (inclusive) and 1. In this implementation, the paradigm for evaluating the implementation cost may be as follows:

### Model

$$IS = {\int }_{0}^{T} [ ( S - δ ) f + ( S + δ + {α ( \frac{y}{\overline{y}} )}^{γ} ) y ] d t - N \cdot {S}_{0}$$

$${\int }_{0}^{T} ( y + f ) dt = N$$

$$dS = σ dz$$

$$y = y ( t ) ,$$

### Utility

U=E[IS]+κ Var[IS]

### Results

We need to solve the following second-order ODE

$$\frac{αγ ( 1 + γ )}{{\overline{y}}^{γ}} \frac{\ddot{X}}{{( - \dot{X} - f )}^{1 - γ}} = ( μ - f η ) + 2 {κσ}^{2} X$$

with the boundary condition

$$\{ \begin{matrix}X ( 0 ) = N \\ X ( T ) = 0\end{matrix}$$

The above ODE can be solved efficiently by any standard ODE solver such as the one provided by IMSL.

In another implementation, the user may set the temporary market impact function exponent γ to 1. In this implementation, the paradigm for evaluating the implementation cost may be as follows (for notational brevity, zero drift and zero permanent impact is assumed):

### Model

$$IS = {\int }_{0}^{T} [ ( S - δ ) f + ( S + δ + α \frac{y}{\overline{y}} ) y ] dt - N \cdot {S}_{0}$$

$${\int }_{0}^{T} ( y + f ) dt = n , \qquad dS = σ dz , \qquad y = y ( t ) ,$$

### Utility

U=E[IS]+κ Var[IS]

### Definitions

$$τ = \sqrt{\frac{α}{{κσ}^{2} \overline{y}}} {T}^{*} = min [ T , τ {sinh}^{- 1} ( \frac{N}{f τ} ) ]$$

$$β = \frac{{T}^{*}}{τ} , \tilde{t} = t / {T}^{*} , \tilde{X} = X / N , \tilde{f} = f / ( N / {T}^{*} ) , \tilde{y} = y / ( N / {T}^{*} )$$

### Results

$$\tilde{y} ( \tilde{t} ) = \{ \begin{matrix}β \frac{cosh ( β ( 1 - \tilde{t} ) )}{sinh ( β )} - \tilde{f} when & \tilde{t} \leq 1 \\ 0 & \tilde{t} > 1\end{matrix} \\ \overline{X} ( \overline{t} ) = \{ \begin{matrix}\frac{sinh ( β ( 1 - \tilde{t} ) )}{sinh ( β )} when & \tilde{t} \leq 1 \\ 0 & \tilde{t} > 1\end{matrix} \\ \frac{E [ IS ]}{N} = δ ( 1 - 2 \tilde{f} ) + {\underbrace{α \frac{N}{\overline{y} T}}}_{VWAP Market Impact} \cdot ξ1 \\ \frac{Std [ IS ]}{N} = {\underbrace{σ \sqrt{\frac{T}{3}}}}_{VWAP Risk} \cdot ξ2 \\ U = E [ IS ] + {κ ( Std [ IS ] )}^{2} \\ ξ1 = ( \tilde{f} ( \tilde{f} - 2 ) + β \frac{0.5 \cdot sinh ( 2 β ) + β}{cosh ( 2 β ) - 1} ) \frac{T}{{T}^{*}} \\ ξ2 = \sqrt{\frac{1}{β} \cdot \frac{0.5 \cdot sinh ( 2 β ) - β}{cosh ( 2 β ) - 1}} \cdot \sqrt{\frac{3 {T}^{*}}{T}}$$

In another embodiment, an adaptive mean-variance strategy for trading a single stock with arrival price benchmark may be used. An adaptive trading strategy is a trading policy that depends on time as well as the state space. The state space includes the remaining position and some representation of the price history. In the absence of persistent major parameter mis-estimates on such things as drift, an adaptive strategy leads to lower implementation cost on average than its non-adaptive counterpart. Assume market price follows a driftless arithmetic random walk dS=σdB(t). Consider an order of size N with trading horizon T. For brevity, assume zero limit-order fill rate (i.e., f=0). Let X(t) denote the remaining position of the order, and the position change is due to a trading policy y(⋅), i.e., dX(t)=−y(⋅)dt. The implementation shortfall IS may have the following dynamics: d(IS)=(ϕy²+μX)dt+σXdB(t), where a linear temporary impact is assumed and

$$φ = \frac{α}{\overline{y}}$$

is the impact coefficient. Let C represent the difference between IS and its expected value, namely, C=IS−E[IS]. Then E[C]=0. Moreover, d(C)=[ϕ(y²−Ey²)+μ(X−EX)]dt+σXdB(t), where Ey² indicates the expected value of the random variable y². The objective is to find the optimal trading policy y* that minimizes the objective function F=E[IS(T)]+Λ· Var[IS(T)] where κ is the risk aversion coefficient:

$$\begin{matrix}{y}^{*} = {arg min}_{y ( \cdot )} F \\ = {arg min}_{y ( \cdot )} \{ E [ IS ( T ) ] + κ \cdot Var [ IS ( T ) ] \}\end{matrix}$$

In one implementation, the optimal adaptive strategy may be formulated in a form amenable to efficient numerical procedures. Let the state space be ft, X, Cl. the whole objective function becomes:

F=∫₀^{T}(ϕE[y²]+κσ²E[X²]+2κϕE[Cy²])dt

To find an efficient way to calculate E[IS(T)] and Var[IS(T)], the dynamics of the first and second moments of X and C may be as follows:

$$\begin{matrix}\begin{matrix}\frac{dE [ IS ]}{dt} = φ E [ {y}^{2} ] \\ = φ {\tilde{y}}^{2} since E [ C ] is equal to zero\end{matrix} & E [ IS ] \\ \begin{matrix}\frac{dE [ X ]}{dt} = - E [ y ] \\ \approx - \tilde{y} ( 1 + \frac{α}{2} EC - \frac{{α}^{2}}{8} E [ {C}^{2} ] ) \\ by second \text{-} order Taylor expansion \\ = - \tilde{y} ( 1 + \frac{{α}^{2}}{8} E [ {C}^{2} ] ) since E [ C ] is equal to zero\end{matrix} & E [ X ] \\ \begin{matrix}\frac{\\ dE [ {X}^{2} ]}{dt} = - 2 E [ yX ] \\ \approx - 2 \tilde{y} ( E [ X ] + \frac{α}{2} E [ XC ] - \frac{{α}^{2}}{8} E [ {XC}^{2} ] ) \\ by second \text{-} order Taylor expansion\end{matrix} & E [ {X}^{2} ] \\ \begin{matrix}\frac{d Var [ IS ]}{dt} = \frac{dE [ {C}^{2} ]}{dt} \\ = E [ 2 φ C ( {y}^{2} - {Ey}^{2} ) + {σ}^{2} {X}^{2} ] \\ = 2 αφ {\tilde{y}}^{2} E [ {C}^{2} ] + {σ}^{2} E [ {X}^{2} ]\end{matrix} & Var [ IS ] \\ \begin{matrix}\frac{dE [ XC ]}{dt} = E [ φ X ( {y}^{2} - {Ey}^{2} ) - yC ] \\ = αφ {\tilde{y}}^{2} E [ XC ] - \tilde{y} E [ C \sqrt{1 + α C} ] \\ \approx αφ {\tilde{y}}^{2} E [ XC ] - \frac{α}{2} \tilde{y} E [ {C}^{2} ] + \frac{{α}^{2}}{8} \tilde{y} E [ {C}^{3} ] \\ by second \text{-} order Taylor expansion\end{matrix} & E [ XC ]\end{matrix}$$

In the case of a linear market impact function, the four ordinary differential equations (ODEs) and boundary conditions may be as follows:

$$\frac{dE [ X ]}{dt} = - \tilde{y} ( 1 - \frac{ {a}^{2}}{8} E [ {C}^{2} ] )$$

$$\frac{dE [ {X}^{2} ]}{dt} = - 2 \tilde{y} ( E [ X ] + \frac{a}{2} E [ XC ] )$$

$$\frac{dE [ {C}^{2} ]}{dt} = 2 αφ {\tilde{y}}^{2} E [ {C}^{2} ] + {σ}^{2} E [ {X}^{2} ]$$

$$\frac{dE [ XC ]}{dt} = αφ {\tilde{y}}^{2} E [ XC ] - \frac{a}{2} \tilde{y} E [ {C}^{2} ]$$

$$E [ X ] {\vert}_{t = 0} = N$$

$$E [ {C}^{2} ] {\vert}_{t = 0} = 0$$

$$E [ {X}^{2} ] {\vert}_{t = 0} = {N}^{2}$$

$$E [ XC ] {\vert}_{t = 0} = 0$$

An efficient one-dimensional search over a to find the optimal a* that minimizes the mean-variance objective function may be done. For each potential value of a the above system of ODEs may be solved, which can be done on the order of one hundredth of a second.

In the case of a power-law market impact function, the four ordinary differential equations (ODEs) and boundary conditions may be as follows:

$$\frac{dE [ X ]}{dt} = - \tilde{y} ( 1 - \frac{γ {a}^{2}}{2 {( 1 + γ )}^{2}} E [ {C}^{2} ] )$$

$$\frac{dE [ {X}^{2} ]}{dt} = - 2 \tilde{y} ( E [ X ] + \frac{a}{1 + γ} E [ XC ] )$$

$$\frac{dE [ {C}^{2} ]}{dt} = 2 αφ {\tilde{y}}^{1 + γ} E [ {C}^{2} ] + {σ}^{2} E [ {X}^{2} ]$$

$$\frac{dE [ XC ]}{dt} = αφ {\tilde{y}}^{1 + γ} E [ XC ] - \frac{1}{1 + γ} α \tilde{y} E [ {C}^{2} ]$$

$$E [ X ] {\vert}_{t = 0} = N$$

$$E [ {C}^{2} ] {\vert}_{t = 0} = 0$$

$$E [ {X}^{2} ] {\vert}_{t = 0} = {N}^{2}$$

$$E [ XC ] {\vert}_{t = 0} = 0$$

As in the linear-market-impact case, an efficient one-dimensional search over a to find the optimal a* that minimizes the mean-variance objective function may be done.

In another embodiment, a non-adaptive mean-variance strategy for trading a portfolio of stocks with arrival price benchmark may be used. In this embodiment, the price of the ith stock Ŝᵢ(t) is assumed to have an arithmetic random walk as follows:

$$d {\hat{S}}_{i} ( t ) = {μ}_{i} dt + {\sum }_{j} {Γ}_{ij} d {B}_{j} ( t ) = {μ}_{i} dt + {Γ}_{i} d B ( t )$$

The random walks of the ith stock and the jth stock are correlated, and the correlation can be described using the covariance matrix Σ, where its element is:

Σᵢⱼ=cov(dŜᵢ(t),dŜⱼ(t))⇒Σ=ΓΓ^{T}

In one implementation, the paradigm for evaluating the implementation cost may be as follows:

The expected cost can be written as

E[IS]=∫₀^{T}(2\tilde{μ}^{T}·ΛZ(t)+Ż^{T}(t)·Ż(t))dt+δ^{T}·N,

and the execution risk is

$$Var [ IS ] = {\int }_{0}^{T} \frac{1}{κ} {Z}^{T} \cdot Λ Z ( t ) dt .$$

The close-form solutions may be obtained as follows:

$$E [ IS ] = {\tilde{Z}}^{T} \cdot {M}_{1} \tilde{Z} + {\tilde{μ}}^{T} \cdot {M}_{2} \tilde{Z} + {\tilde{μ}}^{T} \cdot {M}_{3} \tilde{μ} + {δ}^{T} \cdot N$$

$$κVar [ IS ] = {\tilde{Z}}^{T} \cdot {M}_{4} \tilde{Z} + {\tilde{μ}}^{T} \cdot {M}_{5} \tilde{Z} + {\tilde{μ}}^{T} \cdot {M}_{6} \tilde{μ}$$

$${M}_{1} = \frac{1}{2} λ \frac{sinh ( 2 λ T ) + 2 λ T}{cosh ( 2 λ T ) - 1}$$

$${M}_{2} = 2 λ \frac{cosh ( λ T ) - 1}{sinh ( λ T )} + 2 λ \frac{( cosh ( λ T ) - 1 ) ( sinh ( λ T ) - λ T )}{cosh ( 2 λ T ) - 1}$$

$${M}_{3} = 4 λ \frac{cosh ( λ T ) - 1}{sinh ( λ T )} - 2 Λ T + 2 λ \frac{( cosh ( λ T ) - 1 ) ( sinh ( λ T ) - λ T )}{cosh ( 2 λ T ) - 1}$$

$${M}_{4} = \frac{1}{2} λ \frac{sinh ( 2 λ T ) - 2 λ T}{cosh ( 2 λ T ) - 1}$$

$${M}_{5} = 2 λ \frac{( cosh ( λ T ) - 1 ) ( sinh ( λ T ) + λ T )}{cosh ( 2 λ T ) - 1} - 2 λ \frac{cosh ( λ T ) - 1}{sinh ( λ T )}$$

$${M}_{6} = 2 λ \frac{( cosh ( λ T ) - 1 ) ( sinh ( λ T ) + λ T )}{cosh ( 2 λ T ) - 1} - 4 λ \frac{cosh ( λ T ) - 1}{sinh ( λ T )} + Λ T$$

$$λ = {Λ}^{1 / 2}$$

The implementation cost may be written as follows:

$$\begin{matrix}IC = E [ IS ] + κVar [ IS ] \\ = {\tilde{Z}}^{T} \cdot λ \frac{cosh ( λ T )}{sinh ( λ T )} \tilde{Z} + {\tilde{μ}}^{T} \cdot 2 λ \frac{cosh ( λ T ) - 1}{sinh ( λ T )} \tilde{Z} + \\ {\tilde{μ}}^{T} \cdot ( 2 λ \frac{cosh ( λ T ) - 1}{sinh ( λ T )} - Λ T ) \tilde{μ} + {δ}^{T} \cdot N\end{matrix}$$

In the special case with zero drift, the terms become simplified as follows:

$$E [ IS ] = \frac{1}{2} {\tilde{Z}}^{T} \cdot λ \frac{sinh ( 2 λ T ) + 2 λ T}{cosh ( 2 λ T ) - 1} \tilde{Z}$$

$$κVar [ IS ] = \frac{1}{2} {\tilde{Z}}^{T} \cdot λ \frac{sinh ( 2 λ T ) + 2 λ T}{cosh ( 2 λ T ) - 1} \tilde{Z}$$

$$IC = {\tilde{Z}}^{T} \cdot λ \frac{cosh ( λ T )}{sinh ( 2 λ T )} \tilde{Z} + {δ}^{T} \cdot N$$

In another implementation, a commercial optimizer may be used to obtain the trajectories of the constrained problem, and the trajectories obtained in the optimizer and the closed-form objective function obtained analytically may be combined as follows. Based on the optimal trajectories obtained in the optimizer, the entire trading horizon is divided into sub-intervals [t₀=0, t₁, t₂, . . . , tₙ₋₁, tₙ=T], where a stock is either trading or not trading during each sub-interval. The trajectories will also provide the remaining shares of the portfolio at the end of each sub-period, [N₁, N₂, . . . , Nₙ=0]. When trading during the sub interval ending at t, use the analytical framework to optimize with the boundary condition X(tᵢ)=Nᵢ. Periodically the optimizer is called to update the sub-interval information.

The following notation is used. The elements of the stock position vector X are re-arranged such that the actively traded stocks are listed first, followed by the stocks not trading during the sub-interval:

$$X = [ \begin{matrix}{X}_{1} \\ {X}_{2}\end{matrix} ]$$

The diagonal matrix of temporary impact coefficient, the covariance matrix, and the drift term may also be re-arranged accordingly:

$$Φ = [ \begin{matrix}{Φ}_{1} & 0 \\ 0 & {Φ}_{2}\end{matrix} ] \cdot Σ = [ \begin{matrix}{Σ}_{11} & {Σ}_{12} \\ {Σ}_{12}^{T} & {Σ}_{22}\end{matrix} ] \cdot μ = [ \begin{matrix}{μ}_{1} \\ {μ}_{2}\end{matrix} ]$$

Denote the terminal stock positions as:

$$X ( {t}_{i} ) = [ \begin{matrix}{N}_{1} \\ {N}_{2}\end{matrix} ]$$

Denote the quantities traded during the sub-intervals as:

$$X ( {t}_{i - 1} ) - X ( {t}_{i} ) = [ \begin{matrix}Δ {N}_{1} \\ Δ {N}_{2}\end{matrix} ] = [ \begin{matrix}Δ {N}_{1} \\ 0\end{matrix} ]$$

The solution is given as follows:

$${X}_{1} = {Φ}_{1}^{- 1 / 2} {P}^{T} Z$$

$${\dot{X}}_{1} = {Φ}_{1}^{- 1 / 2} {P}^{T} \dot{Z}$$

$$Z = {\tilde{Z}}_{0} + \frac{sinh ( {Λ}^{1 / 2} ( {t}_{i} - t ) )}{sinh ( {Λ}^{1 / 2} ( {t}_{i} - {t}_{i - 1} ) )} \tilde{Z} + ( \frac{sinh ( {Λ}^{1 / 2} ( t - {t}_{i - 1} ) )}{sinh ( {Λ}^{1 / 2} ( {t}_{i} - {t}_{i - 1} ) )} + \frac{sinh ( {Λ}^{1 / 2} ( {t}_{i} - t ) )}{sinh ( {Λ}^{1 / 2} ( {t}_{i} - {t}_{i - 1} ) )} - 1 ) \tilde{μ}$$

$$\dot{Z} = - \frac{cosh ( {Λ}^{1 / 2} ( {t}_{i} - t ) )}{sinh ( {Λ}^{1 / 2} ( {t}_{i} - {t}_{i - 1} ) )} {Λ}^{1 / 2} \tilde{Z} + ( \frac{cosh ( {Λ}^{1 / 2} ( t - {t}_{i - 1} ) )}{sinh ( {Λ}^{1 / 2} ( {t}_{i} - {t}_{i - 1} ) )} - \frac{cosh ( {Λ}^{1 / 2} ( {t}_{i} - t ) )}{sinh ( {Λ}^{1 / 2} ( {t}_{i} - {t}_{i - 1} ) )} ) {Λ}^{1 / 2} \tilde{μ}$$

$$\tilde{Z} = P {Φ}_{1}^{1 / 2} Δ {N}_{1}$$

$${\tilde{Z}}_{0} = P {Φ}_{1}^{1 / 2} Δ {N}_{1}$$

$$\tilde{μ} = \frac{1}{2} {Λ}^{- 1} P {Φ}_{1}^{- 1 / 2} ( {μ}_{1} + 2 {Σ}_{12} {X}_{2} )$$

$$Λ = {κΦ}_{1}^{- 1 / 2} {Σ}_{11} {Φ}_{1}^{- 1 / 2}$$

$$λ = {Λ}^{1 / 2}$$

Let T=tᵢ−tᵢ₋₁, and the cost function can be computed as follows:

$$IC = {\tilde{Z}}^{T} \cdot λ \frac{cosh ( λ T )}{sinh ( λ T )} \tilde{Z} + {\tilde{μ}}^{T} \cdot 2 λ \frac{cosh ( λ T ) - 1}{sinh ( λ T )} \tilde{Z} + {\tilde{Z}}_{0}^{T} \cdot 2 λ \frac{cosh ( λ T ) - 1}{sinh ( λ T )} \tilde{Z} + {\tilde{Z}}_{0}^{T} \cdot 4 λ \frac{cosh ( λ T ) - 1}{sinh ( λ T )} \tilde{μ} + {\tilde{μ}}^{T} \cdot ( 2 λ \frac{cosh ( λ T ) - 1}{sinh ( λ T )} - Λ T ) \tilde{μ} + {δ}^{T} \cdot Δ N + T ( {μ}_{2}^{T} \cdot {X}_{2} + κ {X}_{2}^{T} \cdot {Σ}_{22} {X}_{2} + {\tilde{Z}}_{0}^{T} \cdot Λ {\tilde{Z}}_{0} )$$

Using the linear impact model, both the future and current risk-adjusted costs are quadratic functions, so the optimal trading quantities can be determined analytically, and the optimal trading quantities can be obtained by minimizing the sum of the costs as follows:

$$\begin{matrix}C = {C}_{0} ( Δ N ) + {C}_{1} ( N - Δ N ) \\ = Δ {N}^{T} \cdot ( {A}_{0} + {A}_{1} ) Δ N + {( {b}_{0} - {b}_{1} - 2 {A}_{1} N )}^{T} \cdot Δ N + {N}^{T} \cdot {A}_{1} N + {b}_{1}^{T} \cdot N\end{matrix}$$

In another implementation, a dollar-neutral penalty term may also be added to the objective function to take into account dollar-neutrality as follows:

$$\begin{matrix}IC = {\int }_{0}^{T} [ {δ}^{T} y - {δ}^{T} f + {( Φ y )}^{T} y + {μ}^{T} X + κ {X}^{T} Σ X + {{λσ}_{B}^{2} ( {1}^{T} X )}^{2} ] dt \\ = {\int }_{0}^{T} [ {δ}^{T} y - {δ}^{T} f + {( Φ y )}^{T} y + {μ}^{T} X + \\ ( κ + λ ) {X}^{T} ( \frac{κ}{κ + λ} Σ + \frac{λ}{κ + λ} 1 {σ}_{B}^{2} {1}^{T} ) X ] dt\end{matrix}$$

In another implementation, time-dependent parameters maybe used. Let's break up the horizon [0; T] into two parts, namely, [0,T₁] and [T₁, T]. The parameters used in [0,T₁] are based on current market conditions, while the parameters used in [T₁, T] are estimated using some smoothing mechanism that takes into account both current observations and historical patterns. In this implementation, the total implementation cost may be expressed as follows:

$$\begin{matrix}IC = {\int }_{0}^{{T}_{1}} ( {δ}_{1}^{T} y + {y}^{T} {Φ}_{1} y + κ {X}^{T} {Σ}_{1} X ) dt + {\int }_{{T}_{1}}^{T} ( {δ}_{2}^{T} y + {y}^{T} {Φ}_{2} y + κ {X}^{T} {Σ}_{2} X ) dt \\ = {\int }_{0}^{{T}_{1}} ( {δ}_{1}^{T} y + {\dot{Z}}_{1}^{T} {\dot{Z}}_{1} + {Z}_{1}^{T} {Λ}_{1} {Z}_{1} ) dt + {\int }_{{T}_{1}}^{T} ( {δ}_{2}^{T} y + {\dot{Z}}_{2}^{T} {\dot{Z}}_{2} + {Z}_{2}^{T} {Λ}_{2} {Z}_{2} ) dt\end{matrix}$$

where the subscripts 1 and 2 indicate the association with the first segment [0,T₁] and the second segment [T₁, T], respectively. Z₁ and Z₂ are some orthonormal transformations of X. The boundary conditions are X(o)=N and X(T)=0.

The optimal cost-to-go value for [T₁, T] is equal to:

C(T₁,T)=δ₂^{T}X(T₁)+[Z₂(T₁)]^{T}[Λ₂^{1/2} coth(Λ₂^{1/2}(T−T₁))]Z₂(T₁)

The optimal cost-to-go value for [0,T₁] is equal to:

C(0,T₁)=δ₁^{T}[N−X(T₁)]+[Z₁(0)−Z₁(T₁)]^{T}[Λ₁^{1/2} coth(Λ₁^{1/2}T₁)][Z₁(0)−Z₁(T₁)]+2[Z₁(T₁)]^{T}[Λ₁^{1/2}(coth(Λ₁^{1/2}T₁)−csch(Λ₁^{1/2}T₁)][Z₁(0)−Z₁(T₁)]

The total cost-to-go value for [0,T] is equal to:

C(0,T)=C(0,T₁)+C(T₁,T)

In theory, the MCP PLATFORM may use more segments than just two, albeit at the cost of heavier computational burden. The MCP PLATFORM may apply this approach in a rolling horizon fashion so that it may distinguish between current market conditions and expected market conditions throughout the execution.

In another embodiment, a dynamic mean-variance strategy for trading a portfolio of stocks with arrival price benchmark may be used. Along the same lines as in the single-stock case, the dynamic portfolio execution problem is to minimize the following objective function:

F=E[∫₀^{T}(δ^{T}y+y^{T}Φy+κX^{T}ΣX)dt]+2κ∫₀^{T} Cov(IS,y^{T}Φy)dt

In this embodiment, the following ODEs and corresponding boundary conditions may be used:

$$\frac{dE [ X ]}{dt} = - ( 1 - \frac{{α}^{2}}{8} E [ {C}^{2} ] ) \tilde{y}$$

$$\frac{dE [ {X}^{T} Σ X ]}{dt} = - 2 {\tilde{y}}^{T} Σ ( E [ X ] + \frac{a}{2} E [ CX ] )$$

$$\frac{dE [ {C}^{2} ]}{dt} = 2 α {\tilde{y}}^{T} Φ \tilde{y} E [ {C}^{2} ] + E [ {X}^{T} Σ X ]$$

$$\frac{dE [ CX ]}{dt} = α {\tilde{y}}^{T} Φ \tilde{y} E [ CX ] - \frac{a}{2} E [ {C}^{2} ] \tilde{y}$$

$$E [ X ] {\vert}_{t = 0} = N$$

$$E [ {C}^{2} ] {\vert}_{t = 0} = 0$$

$$E [ {X}^{T} Σ X ] {\vert}_{t = 0} = {N}^{T} Σ N$$

$$E [ CX ] {\vert}_{t = 0} = 0$$

In another embodiment, a dynamic mean-variance strategy for trading a single stock with VWAP benchmark may be used. Let vₜ be the normalized instantaneous volume profile corresponding to [0,T]. Denote the cumulative volume profile ∫₀^{t} vₜdt by Vₜ. Basically, Vₜ is equal to the market volume in [0, t] as a fraction of the market volume in [0,T]. Then V₀=0 and V_{T}=1. Also, by definition, dVₜ=vₜdt. If the volume profile is flat (i.e., volume time instead of calendar time is used), then Vₜ is equal to t/T. Since the total market volume in [0,T] is not observable until time T and the final market volume is countable, Vₜ is a semimartingale.

Let Sₜ be the mid-quote price that follows some arithmetic random walk. Then the VWAP price in the interval [0,T] is:

—VWAP_{[0,T]}=∫₀^{t}SₜdV=∫₀^{t}v·Sₜdt

The VWAP price in the interval [0, t] is:

$${VWAP}_{[ 0 , t ]} = \frac{{\int }_{0}^{t} {v}_{t} \cdot {S}_{t} dt}{{V}_{t}}$$

In the absence of uncertainty in Vₜ, using calculus gives:

$$\begin{matrix}d ( {VWAP}_{t} ) = \frac{{v}_{t}}{{V}_{t}} ( {P}_{t} - {VWAP}_{t} ) dt \\ = ( {P}_{t} - {VWAP}_{t} ) ) d ( log V )\end{matrix}$$

For uncertain volume profile, one option is to model Vₜ as a Brownian bridge. Let vₜ represent the expected instantaneous volume profile. Let σ be the volatility corresponding to the Brownian bridge. In this case dVₜ=vₜdt+σd(BB) where BB is a standard Brownian bridge and can be assumed to be independent of the price Brownian motion.

Let Cov(Pₜ,Vₜ) be the instantaneous covariance between Sₜ and Vₜ. The implementation shortfall corresponding to the VWAP benchmark is as follows:

$$\begin{matrix}IS = [ {\int }_{0}^{T} {α ( \frac{y}{\overline{y}} )}^{γ} \cdot ydt + {\int }_{0}^{T} ( f + y ) {S}_{t} dt ] - N \cdot {\int }_{0}^{T} v \cdot Sdt \\ = [ {\int }_{0}^{T} {α ( \frac{y}{\overline{y}} )}^{γ} \cdot ydt + {\int }_{0}^{T} Xds + {NS}_{0} ] - N \cdot {\int }_{0}^{T} SdV \\ = [ {\int }_{0}^{T} {α ( \frac{y}{\overline{y}} )}^{γ} \cdot ydt + {\int }_{0}^{T} XdS + {NS}_{0} ] - N \cdot {S}_{T} + \\ N \cdot {\int }_{0}^{T} VdS - N {\int }_{0}^{T} Cov ( {S}_{t} , {V}_{t} ) dt \\ = {\int }_{0}^{T} {α ( \frac{y}{\overline{y}} )}^{γ} \cdot ydt + {\int }_{0}^{T} [ X - N \cdot ( 1 - V ) ] dS - N {\int }_{0}^{T} Cov ( {S}_{t} , {V}_{t} ) dt\end{matrix}$$

Since the last term is exogenous (i.e., it is constant from the mean-variance perspective), it may be dropped it from consideration. Assuming dS=σdB, then:

$$dIS = {α ( \frac{y}{\overline{y}} )}^{γ} \cdot ydt + σ [ X - N \cdot ( 1 - V ) ] dB$$

Denote the cumulative trade quantity by Yₜ. In this case, Yₜ=N−Xₜ. Define P&L at time t by ∫₀^{t} dIS, namely:

$$\begin{matrix}{IS}_{t} = {\int }_{0}^{t} {α ( \frac{y}{\overline{y}} )}^{γ} \cdot ydt + {\int }_{0}^{t} [ X - N \cdot ( 1 - V ) ] dS \\ = {\int }_{0}^{t} {α ( \frac{y}{\overline{y}} )}^{γ} \cdot ydt + {\int }_{0}^{t} ( f + y ) Sdt + ( {NV}_{t} - {Y}_{t} ) {S}_{t} - {NV}_{t} \cdot {VWAP}_{t}\end{matrix}$$

where NVₜ is the target cumulative trade quantity at time t. The sum of the first two terms in the last equation corresponds to the actual cost paid for buying Yₜ shares in [0, t). The sum of this actual cost and the third term represents the “realized” cost of trading NVₜ shares by time t (assuming trading at time t is frictionless). In other words, if Yₜ is greater (less) than NVₜ, the MCP PLATFORM sells (buys) the difference at midquote at time t. The last term in the above equation is NVₜ times the realized VWAP price between o and t. Therefore, P&L at time t is the difference between the “realized” cost and the benchmark cost.

If the objective function is set to be of quadratic utility type, then the dynamic objective function is as follows:

F=E[∫₀^{T}ϕy²+κσ²[X−N(1−V)]²+2κϕCy²dt]

and fits into the adaptive stochastic control framework.

Define VWAP slippage, denoted by VS, to be

$$\frac{\overline{S} - VWAP}{{S}_{0}} .$$

Let S̅ indicate the average execution price seen by VWAP in [0,T]. Let M̅I̅ represent the average (relative) market impact incurred in [0,T], namely,

$$\overline{MI} = \frac{I}{T} {\int }_{0}^{T} \frac{{MI}_{t}}{{S}_{0}} dt .$$

Let PR be the participation rate, namely, PR=N/V_{T}. In this case:

$$VS = \frac{\overline{S} - VWAP}{{S}_{0}} = ( 1 - PR ) \cdot \overline{MI}$$

The above relationship also sheds some light on dynamic VWAP. If, in the presence of volume profile uncertainty, the performance of a dynamic VWAP strategy is close to (1−PR)·M̅I̅, then little may be done to reduce the implementation cost.

In another embodiment, a non-adaptive mean-risk strategy for trading a single stock with arrival price benchmark may be used. In one implementation, the user may set the temporary market impact function exponent γ to between 0 (inclusive) and 1. In this implementation, the paradigm for evaluating the implementation cost may be as follows: Model

$$IS = {\int }_{0}^{T} [ ( S - δ ) f + ( S + δ + α \sqrt{\frac{y}{\overline{y}}} ) y ] dt - {NS}_{0}$$

$${\int }_{0}^{T} ( y + f ) dt = N$$

$$dS = σ dz$$

$$y = y ( t ) .$$

### Utility

U=E[IS]+κ∫₀^{T}σ\sqrt{t}(y+f)dt

### Definitions

$$β = \frac{κσ \sqrt{\overline{y}}}{α}$$

$${T}_{max} = \sqrt{\frac{27 N}{2 {β}^{2}} + {( \frac{27 f}{4 {β}^{2}} )}^{2}} - \frac{27 f}{4 {β}^{2}}$$

$${T}^{*} = min ( T , {T}_{max} )$$

$$b = \frac{κσ \sqrt{{T}^{*}}}{α \sqrt{\frac{N}{\overline{y} {T}^{*}}}} = \frac{β {T}^{*}}{\sqrt{N}}$$

$$α = \frac{4}{9} b + \sqrt{1 - \tilde{f} - \frac{2}{81} {b}^{2}}$$

$$\tilde{t} = t / {T}^{*} , \tilde{X} = X / N , \tilde{f} = f / ( N / {T}^{*} ) , \tilde{y} = y / ( N / {T}^{*} )$$

### Results

$$\tilde{y} ( \tilde{t} ) = \{ \begin{matrix}{( α - \frac{2}{3} b \sqrt{\overline{t}} )}^{2} & when \tilde{t} \leq 1 \\ 0 & \tilde{t} > 1\end{matrix} \\ \tilde{X} ( \tilde{t} ) = \{ \begin{matrix}( 1 - \tilde{t} ) ( 1 + \frac{2}{9} {b}^{2} \tilde{t} ) - \frac{8}{9} ab \tilde{t} ( 1 - \sqrt{\tilde{t}} ) & when \tilde{t} \leq 1 \\ 0 & \tilde{t} > 1\end{matrix} \\ \frac{E [ IS ]}{N} = δ ( 1 - 2 \tilde{f} ) + \underbrace{α \sqrt{\frac{N}{\overline{y} T}}}_{VWAP Matket Impact} \cdot ξ1 \\ \frac{Std [ IS ]}{N} = \underbrace{σ \sqrt{\frac{T}{3}}}_{VWAP Risk} \cdot ξ2 \\ \frac{U}{N} = δ ( 1 - 2 \tilde{f} ) + α \sqrt{\frac{N}{\overline{y} T}} \cdot {ξ}_{3} \\ {ξ}_{1} = ( {α}^{3} - \frac{4}{3} {α}^{2} b + \frac{2}{3} {ab}^{2} - \frac{16}{135} {b}^{3} ) \cdot \sqrt{\frac{T}{{T}^{*}}} \\ {ξ}_{2} = \sqrt{1 - \frac{88}{315} ab + \frac{1}{9} {b}^{2} + \frac{16}{567} {a}^{2} {b}^{2} + \frac{2}{405} {b}^{4}} \cdot \sqrt{\frac{{T}^{*}}{T}} \\ {ξ}_{3} = ( {α}^{3} - \frac{2}{3} {α}^{2} b + \frac{8}{135} {b}^{3} ) \cdot \sqrt{\frac{T}{{T}^{*}}}$$

In another implementation, the user may set the temporary market impact function exponent γ to 1. In this implementation, the paradigm for evaluating the implementation cost may be as follows (for notational brevity, zero drift and zero permanent impact is assumed): Model

$$IS = {\int }_{0}^{T} [ ( S - δ ) f + ( S + δ + α \frac{y}{\overline{y}} ) y ] dt - {NS}_{0}$$

$${\int }_{0}^{T} ( y + f ) dt = N$$

$$dS = σ dz$$

$$y = y ( t ) .$$

### Utility

U=E[IS]+κ∫₀^{T}σ\sqrt{t}(y+f)dt

### Definitions

$$β = \frac{κσ \overline{y}}{α}$$

$${T}_{max} = {T ( 2 \frac{N}{β {T}^{1.5}} - 2 \frac{fT}{N} \cdot \frac{N}{β {T}^{1.5}} + \frac{2}{3} )}^{2}$$

$${T}^{*} = min ( T , {T}_{max} )$$

$$b = \frac{κσ \sqrt{{T}^{*}}}{α \frac{N}{\overline{y} {T}^{*}}} = \frac{{β ( {T}^{*} )}^{1.5}}{N}$$

$$\tilde{t} = t / {T}^{*} , \tilde{X} = X / N , \tilde{f} = f / ( N / {T}^{*} ) , \tilde{y} = y / ( N / {T}^{*} )$$

### Results

$$\tilde{y} ( \tilde{t} ) = \{ \begin{matrix}1 + \frac{b}{3} - \tilde{f} - \frac{b}{2} \sqrt{t} & when \tilde{t} \leq 1 \\ 0 & \tilde{t} > 1\end{matrix} \\ \tilde{X} ( \tilde{t} ) = \{ \begin{matrix}1 - ( 1 + \frac{b}{3} ) \tilde{t} + \frac{b}{3} {( \tilde{t} )}^{1.5} & when \tilde{t} \leq 1 \\ 0 & \tilde{t} > 1\end{matrix} \\ \frac{E [ IS ]}{N} = δ ( 1 - 2 \tilde{f} ) + \underbrace{α \frac{N}{\overline{y} T}}_{VWAP Matket Impact} \cdot ξ1 \\ \frac{Std [ IS ]}{N} = \underbrace{σ \sqrt{\frac{T}{3}}}_{VWAP Risk} \cdot ξ2 \\ \frac{U}{N} = δ ( 1 - 2 \tilde{f} ) + α \frac{N}{\overline{y} T} \cdot {ξ}_{3} \\ {ξ}_{1} = ( 1 + {\tilde{f}}^{2} - 2 \tilde{f} + \frac{{b}^{2}}{72} ) \cdot \frac{T}{{T}^{*}} \\ {ξ}_{2} = \sqrt{1 - \frac{11}{105} b + \frac{{b}^{2}}{252}} \cdot \sqrt{\frac{{T}^{*}}{T}} \\ {ξ}_{3} = ( 1 + {\tilde{f}}^{2} - 2 \tilde{f} + \frac{2}{3} b - \frac{{b}^{2}}{72} ) \cdot \frac{T}{{T}^{*}}$$

In one implementation, the MCP PLATFORM may re-optimize every time the MCP logic wakes up. Suppose the MCP PLATFORM is at t₀. The goal is to find the optimal ΔN shares that the MCP PLATFORM should trade in the next Δt seconds using market orders, which is part of the optimal policy that minimizes the overall cost integrated from t₀ to T.

The integral from t₀ to T is broken up into two parts, namely, the integral from to t₀ to t₀+Δt (immediate cost) and the integral from t₀ₒ+Δt to T (future cost). The MCP PLATFORM may approximate the integral from t₀ to t₀+Δt by a rectangle. The first integral may be based on real-time parameter observations and accounts for current market conditions. The second integral may be based on smoothed parameter estimates.

Even though the MCP PLATFORM has a closed-form solution when the cost is integrated from 0 to T, the MCP PLATFORM does not have a closed-form solution when the lower limit of the cost integral is positive. To evaluate the optimal cost-to-go from t₀+Δt to T, the MCP PLATFORM may use efficient numerical techniques built around the closed-form solution corresponding to the cost integral from 0 to T.

For example, the MCP PLATFORM may use Bellman's principle of optimality. Suppose there is an optimal trade-out trajectory from o to T and a tail of the trajectory from t to T for some 0<t<T. If the actual X(t) is equal to the number of remaining shares projected by the initial trade-out trajectory, the tail is the optimal solution that minimizes the cost integral from t to T. If other parameters constant are held constant, X(t) is monotonically increasing in the order size. Therefore, to minimize the cost integral from t to T, the MCP PLATFORM may first perform an efficient search (e.g., bisection search or golden search) that finds the fictitious order size for which X(t) is equal to the observed number of remaining shares at t. For this fictitious order size, there is a closed-form solution of the trade-out trajectory from 0 to T. The tail of this trade-out trajectory from t to T is the optimal solution that minimizes the cost integral from t to T. Therefore, the future cost can be calculated in closed-form.

Let M denote the upper bound on ΔN. For each round-lot ΔN between 0 and M, the MCP PLATFORM may calculate the sum of the immediate cost and future cost and choose the one that minimizes the overall cost.

The immediate cost is a trivially convex function in ΔN. The future cost is a also convex in ΔN since it is convex in X(t)−ΔN. Why is the future cost convex in X(t)−ΔN (i.e., the number of remaining shares at t+Δt)? The incremental cost of trading one more share is increasing in the number of remaining shares, which is a plain English way of defining convexity. Since the sum of two convex functions is convex, the overall cost function is convex in ΔN. As such, when the MCP PLATFORM conducts a search for the optimal ΔN, the MCP PLATFORM can stop as soon as it finds a local optimal solution, which is guaranteed to be globally optimal due to the convexity property of the overall cost function.

In another implementation, the MCP PLATFORM may receive an order having time T beyond market close for the current day. Without loss of generality, let's assume the MCP PLATFORM will be done with execution by the end of the next trading day. Let T₁, T₂ and T₃ indicate current day's market close, next day's market open and next day's market close, respectively. The boundary conditions are X(0)=N, X (T₃)=0 and X(t)=M∀T₁<t<T₂, where M is the remaining quantity at the end of the current trading day. The optimal M* can be obtained using an efficient one-dimensional search technique. Let σ₁ and σ₂ indicate intra-day volatility and overnight-holding volatility, respectively. Then the MCP PLATFORM can break up a penalty function for risk into three parts as follows:

$${\int }_{0}^{{T}_{1}} \frac{{σ}_{1} X}{2 \sqrt{t}} dt + {\int }_{{T}_{1}}^{{T}_{2}} \frac{{σ}_{2} M}{2 \sqrt{t}} dt + {\int }_{{T}_{2}}^{{T}_{3}} \frac{{σ}_{1} X}{2 \sqrt{t}} dt$$

which is equivalent to:

∫₀^{T}σ₁\sqrt{t}ydt+M(σ₂−σ₁)(\sqrt{T₂}−\sqrt{T₁})+∫_{T}_{₂}^{T}^{₃}σ₁\sqrt{t}ydt

The MCP PLATFORM may calculate the cost of optimally trading N−M shares in day 1, for which the MCP PLATFORM has a closed-form solution via Euler-Lagrange equation with the appropriate boundary condition. The overnight holding risk can be calculated in closed-form as well. The cost of optimally trading M shares in day 2 can be computed semi-analytically through a combination of closed-form solution, Bellman's principle of optimality, warm-start-based bisection search and the convexity property.

### MCP PLATFORM Controller

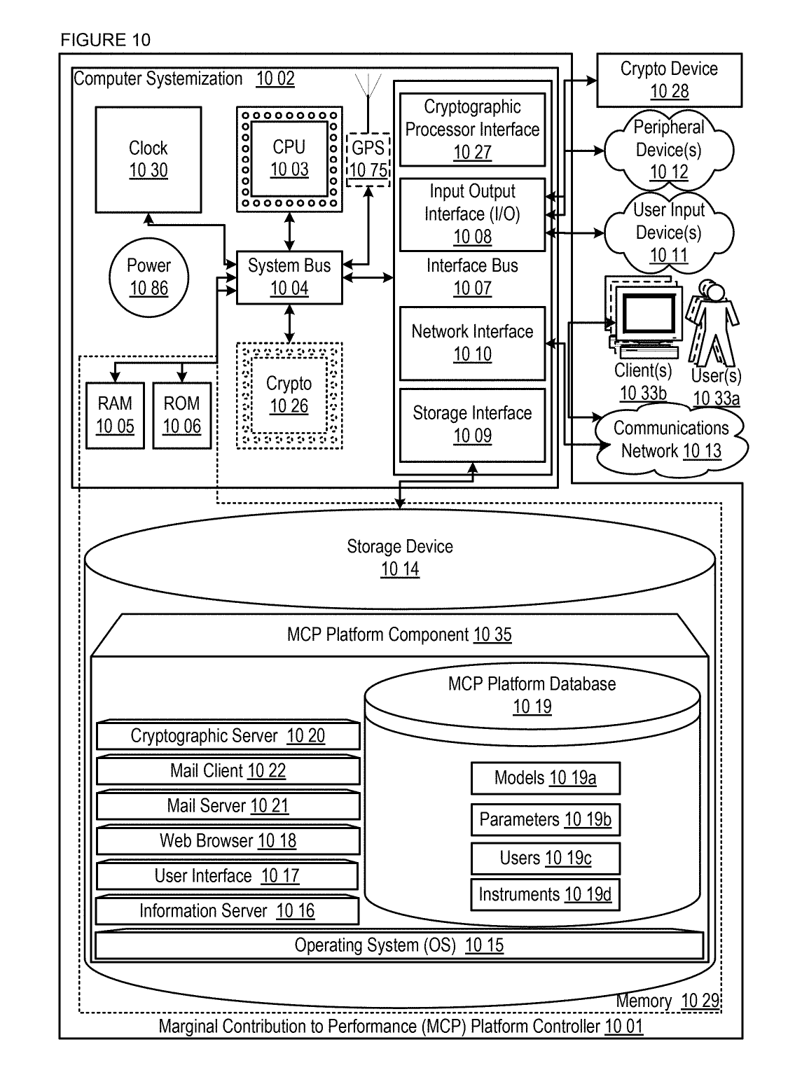

FIG. 10 illustrates inventive aspects of a MCP PLATFORM controller 1001 in a block diagram. In this embodiment, the MCP PLATFORM controller 1001 may serve to aggregate, process, store, search, serve, identify, instruct, generate, match, and/or facilitate interactions with a computer through financial trading technologies, and/or other related data.

Typically, users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MCP PLATFORM controller 1001 may be connected to and/or communicate with entities such as, but not limited to: one or more users from user input devices 1011; peripheral devices 1012; an optional cryptographic processor device 1028; and/or a communications network 1013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MCP PLATFORM controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother)board(s) 1002 having conductive and/or otherwise transportive circuit pathways through which instructions (e.g., binary encoded signals) may travel to effect communications, operations, storage, etc. Optionally, the computer systemization may be connected to an internal power source 1086. Optionally, a cryptographic processor 1026 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MCP PLATFORM controller and beyond through various interfaces. Should processing requirements dictate a greater amount speed and/or capacity, distributed processors (e.g., Distributed MCP PLATFORM), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MCP PLATFORM may be achieved by implementing a microcontroller such as CAST's R8051XC2 microcontroller; Intel's MCS51 (i.e., 8051 microcontroller); and/or the like. Also, to implement certain features of the MCP PLATFORM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MCP PLATFORM component collection (distributed or otherwise) and/or features may be implemented via the microprocessor and/or via embedded components; e.g., via ASIC, coprocessor, DSP, FPGA, and/or the like. Alternately, some implementations of the MCP PLATFORM may be implemented with embedded components that are configured and used to achieve a variety of features or signal processing.

Depending on the particular implementation, the embedded components may include software solutions, hardware solutions, and/or some combination of both hardware/software solutions. For example, MCP PLATFORM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MCP PLATFORM features. A hierarchy of programmable interconnects allow logic blocks to be interconnected as needed by the MCP PLATFORM system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the MCP PLATFORM may be developed on regular FPGAs and then migrated into a fixed version that more resembles ASIC implementations. Alternate or coordinating implementations may migrate MCP PLATFORM controller features to a final ASIC instead of or in addition to FPGAs. Depending on the implementation all of the aforementioned embedded components and microprocessors may be considered the “CPU” and/or “processor” for the MCP PLATFORM.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the MCP PLATFORM thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures maybe employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the MCP PLATFORM controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MCP PLATFORM), architectures may similarly be employed to pool, load balance, and/or otherwise increase the communicative bandwidth required by the MCP PLATFORM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the MCP PLATFORM controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the MCP PLATFORM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the MCP PLATFORM controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the MCP PLATFORM component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the MCP PLATFORM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MCP PLATFORM controller to communicate with other entities through a communications network 1013. Various communication protocols may be used by the MCP PLATFORM controller as a subcarrier transport mechanism for interaction, such as, but not limited to: multicast, TCP/IP, UDP, unicast, and/or the like.

### Information Server

An information server component 1016 is a stored program component that is executed by a CPU. The information server maybe a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MCP PLATFORM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols maybe employed across various ports, e.g., FTP communications across port 21, and/or the like. An information server may communicate to and/or with other components in a component collection, including itself, and/or facilities of the like. Most frequently, the information server communicates with the MCP PLATFORM database 1019, operating systems, other program components, user interfaces, Web browsers, and/or the like.

Access to the MCP PLATFORM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MCP PLATFORM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MCP PLATFORM as a query. Upon generating query results from the query, the results are passed over the bridge mechanism, and maybe parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application maybe developed to perform similar functions of both. The combined application would similarly affect the obtaining and the provision of information to users, user agents, and/or the like from the MCP PLATFORM enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MCP PLATFORM.

Access to the MCP PLATFORM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP₃, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MCP PLATFORM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MCP PLATFORM component to engage in secure transactions if so desired. The cryptographic component facilitates the secure accessing of resources on the MCP PLATFORM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MCP PLATFORM Database

The MCP PLATFORM database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MCP PLATFORM database may be implemented using various standard data-structures, such as an array, hash, (linked) list, struct, structured text file (e.g., XML), table, and/or the like. Such data-structures maybe stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the MCP PLATFORM database is implemented as a data-structure, the use of the MCP PLATFORM database 1019 may be integrated into another component such as the MCP PLATFORM component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-e. A Users table 1019a may include fields such as, but not limited to: model_ID, model_name, parameter_ID(s), instrument_IDs, model_type, model, and/or the like. A Parameters table 1019b may include fields such as, but not limited to: parameter_ID, parameter_name, parameter_value(s), value_source(s), parameter_history, parameter_type, and/or the like. A Users table 1019c may include fields such as, but not limited to: user_ID, user_name, contact_info, login, password, instrument_ID, portfolio, trading_history, risk_aversion, payment_identifier(s), and/or the like. An Instruments table 1019d may include fields such as, but not limited to: instrument_ID, instrument_type, parameter_ID(s), current_market_price, historical_market_price, volume, trade_history, underlying_entity, exchange, trading_restrictions, volatility, and/or the like. A market data table 1019e may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the MCP PLATFORM database may interact with other database systems. For example, employing a distributed database system, queries and data access by search MCP PLATFORM component may treat the combination of the MCP PLATFORM database, an integrated data security layer database as a single database entity.

In one embodiment, user programs may contain various user interface primitives, which may serve to update the MCP PLATFORM. Also, various accounts may require custom database tables depending upon the environments and the types of clients the MCP PLATFORM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-e. The MCP PLATFORM may be configured to keep track of various settings, inputs, and parameters via database controllers.

The MCP PLATFORM database may communicate to and/or with other components in a component collection, including itself, and/or facilities of the like. Most frequently, the MCP PLATFORM database communicates with the MCP PLATFORM component, other program components, and/or the like. The database may contain, retain, and provide information regarding other nodes and data.

### The MCP PLATFORMs

The MCP PLATFORM component 1035 is a stored program component that is executed by a CPU. In one embodiment, the MCP PLATFORM component incorporates any and/or all combinations of the aspects of the MCP PLATFORM that was discussed in the previous figures. As such, the MCP PLATFORM affects accessing, obtaining and the provision of information, services, transactions, and/or the like across various communications networks.

The MCP PLATFORM component enables one to access, calculate, engage, exchange, generate, identify, instruct, match, process, search, serve, store, and/or facilitate trading strategies, modeling of market factors and/or parameters associated with tradable financial instruments, optimization of said models, and/or the like and use of the MCP PLATFORM.

The MCP PLATFORM component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MCP PLATFORM server employs a cryptographic server to encrypt and decrypt communications. The MCP PLATFORM component may communicate to and/or with other components in a component collection, including itself, and/or facilities of the like. Most frequently, the MCP PLATFORM component communicates with the MCP is PLATFORM database, operating systems, other program components, and/or the like. The MCP PLATFORM may contain, communicate, generate, obtain, and/or provide program component, system, user, and/or data communications, requests, and/or responses.

### Distributed MCP PLATFORMs

The structure and/or operation of any of the MCP PLATFORM node controller components maybe combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MCP PLATFORM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c−post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

The entirety of this application (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to a be considered limitations on the disclosure as defined by the claims or limitations on equivalents to the claims.

1-9. (canceled)

10. A processor-implemented method for trading a financial instrument using a trading platform communicably coupled to an exchange, the method comprising:
receiving, at the trading platform, an order request identifying order parameters that include a total quantity of shares and a time horizon within which to execute a transaction;
retrieving, from the exchange or a database communicably coupled to the trading platform via a communication network, one or more additional parameters associated with the transaction;
determining whether a required parameter is absent from the order parameters or the additional parameters;
constructing the required parameter in response to determining the required parameter is absent;
analytically evaluating, using a processor under control of the trading platform, a future implementation cost as a function of future number of shares to trade after a current time interval based on at least some of the retrieved parameters;
numerically evaluating, using the processor under control of the trading platform, a current implementation cost as a function of current number of shares to trade during the current time interval based on at least some of the retrieved parameters;
optimizing, using the processor under control of the trading platform, a total implementation cost to determine an optimal current number of shares from the total quantity to trade during the current time interval, wherein the total implementation cost is a sum of the future implementation cost and the current implementation cost;
executing, via the trading platform, an order for the optimal current number of shares of the financial instrument; and
iteratively re-optimizing and re-executing until the total quantity of shares is traded within the time horizon.

11. The processor-implemented method of claim 10, wherein analytically evaluating the future implementation cost comprises using an arithmetic random walk with specified drift and volatility.

12. The processor-implemented method of claim 10, wherein the order parameters further include security parameters, the security parameters comprising a time-varying price and a time-varying volume for the tradable financial instrument.

13. The processor-implemented method of claim 10, wherein analytically evaluating the future implementation cost further comprises calculating an implementation shortfall based on a benchmark cost.

14. The processor-implemented method of claim 13, wherein the benchmark cost is based on an arrive price.

15. The processor-implemented method of claim 13, wherein the benchmark cost is based on a volume weighted average price.

16. The processor-implemented method of claim 10, wherein the order is a market order in a market exchange.

17. The processor-implemented method of claim 16, wherein the required parameter is a beta value indicating risk of the shares relative to other securities traded via the market exchange and constructing the required parameter comprises:
accessing historical market data for the market exchange; and
constructing a measure of beta from the historical market data.

18. The processor-implemented method of claim 10, wherein determining whether a required parameter is absent comprises:
retrieving a list of required parameters from a configuration file stored in the trading platform;
determining whether each required parameter on the list is included in the order parameters or the additional parameters; and
determining a required parameter is absent if a parameter on the list is absent from both the order parameters and the additional parameters.

19. A non-transitory computer-readable medium including code that, when executed by one or more processors of a trading platform, causes the one or more processors to perform operations comprising:
receiving, at the trading platform, an order request identifying order parameters that include a total quantity of shares and a time horizon within which to execute a transaction;
retrieving, from the exchange or a database communicably coupled to the trading platform via a communication network, one or more additional parameters associated with the transaction;
determining whether a required parameter is absent from the order parameters or the additional parameters;
constructing the required parameter in response to determining the required parameter is absent;
analytically evaluating a future implementation cost as a function of future number of shares to trade after a current time interval based on at least some of the retrieved parameters;
numerically evaluating a current implementation cost as a function of current number of shares to trade during the current time interval based on at least some of the retrieved parameters;
optimizing a total implementation cost to determine an optimal current number of shares from the total quantity to trade during the current time interval, wherein the total implementation cost is a sum of the future implementation cost and the current implementation cost;
executing an order for the optimal current number of shares of the financial instrument; and
iteratively re-optimizing and re-executing until the total quantity of shares is traded within the time horizon.

20. The non-transitory computer-readable medium of claim 19, wherein analytically evaluating the future implementation cost comprises using an arithmetic random walk with specified drift and volatility.

21. The non-transitory computer-readable medium of claim 19, wherein the order parameters further include security parameters, the security parameters comprising a time-varying price and a time-varying volume for the tradable financial instrument.

22. The non-transitory computer-readable medium of claim 19, wherein analytically evaluating the future implementation cost further comprises calculating an implementation shortfall based on a benchmark cost.

23. The non-transitory computer-readable medium of claim 22, wherein the benchmark cost is based on an arrive price or a volume weighted average price.

24. The non-transitory computer-readable medium of claim 19, wherein the order is a market order in a market exchange, the required parameter is a beta value indicating risk of the shares relative to other securities traded via the market exchange, and constructing the required parameter comprises:
accessing historical market data for the market exchange; and
constructing a measure of beta from the historical market data.

25. The non-transitory computer-readable medium of claim 19, wherein determining whether a required parameter is absent comprises:
retrieving a list of required parameters from a configuration file stored in the trading platform;
determining whether each required parameter on the list is included in the order parameters or the additional parameters; and
determining a required parameter is absent if a parameter on the list is absent from both the order parameters and the additional parameters.

26. A financial instrument trading system comprising:
one or more processors; and
one or more machine-readable media storing instructions that, when executed by the one or more processors, cause the financial instrument trading system to perform operations comprising:
receiving, at the financial instrument trading system, an order request identifying order parameters that include a total quantity of shares and a time horizon within which to execute a transaction;
retrieving, from the exchange or a database communicably coupled to the financial instrument trading system via a communication network, one or more additional parameters associated with the transaction;
determining whether a required parameter is absent from the order parameters or the additional parameters;
constructing the required parameter in response to determining the required parameter is absent;
analytically evaluating a future implementation cost as a function of future number of shares to trade after a current time interval based on at least some of the retrieved parameters;
numerically evaluating a current implementation cost as a function of current number of shares to trade during the current time interval based on at least some of the retrieved parameters;
optimizing a total implementation cost to determine an optimal current number of shares from the total quantity to trade during the current time interval, wherein the total implementation cost is a sum of the future implementation cost and the current implementation cost;
executing an order for the optimal current number of shares of the financial instrument; and
iteratively re-optimizing and re-executing until the total quantity of shares is traded within the time horizon.

27. The financial instrument trading system of claim 26, wherein analytically evaluating the future implementation cost comprises using an arithmetic random walk with specified drift and volatility.

28. The financial instrument trading system of claim 26, wherein the order is a market order in a market exchange, the required parameter is a beta value indicating risk of the shares relative to other securities traded via the market exchange, and constructing the required parameter comprises:
accessing historical market data for the market exchange; and
constructing a measure of beta from the historical market data.

29. The financial instrument trading system of claim 26, wherein determining whether a required parameter is absent comprises:
retrieving a list of required parameters from a configuration file stored in the financial instrument trading system;
determining whether each required parameter on the list is included in the order parameters or the additional parameters; and
determining a required parameter is absent if a parameter on the list is absent from both the order parameters and the additional parameters.
